(19) United States
(12) Patent Application Publication
(10) Pub. No.: US 2006/0192804 A1
(43) Pub. Date: Aug. 31, 2006

(54) Image forming apparatus

(76) Inventors: Tetsuyoshi Nakata, Tokyo (JP); Katsumi Kobayashi, Tokyo (JP); Takashi Kokawaji, Tokyo (JP); Tomohiro Shuuta, Tokyo (JP)

Correspondence Address: COOPER & DUNHAM, LLP, 1185 AVENUE OF THE AMERICAS, NEW YORK, NY, 10036, US

(21) Appl. No.: 10/553,258

(22) PCT Filed: May 25, 2004
(86) PCT No.: PCT/JP04/07458

§ 371 Date: Oct. 11, 2005

(30) Foreign Application Priority Data
May 30, 2003 (JP) 2003-154259
Jun. 26, 2003 (JP) 2003-183000
Jul. 7, 2003 (JP) 2003-192800
Aug. 22, 2003 (JP) 2003-298088

(51) Int. Cl. B41J 29/38

(52) U.S. Cl. 347/16

(57) ABSTRACT

An image forming apparatus can detect a leading edge and a width of a recording medium with a simple structure so as to prevent erroneous recording. A carriage has a recording head to form the image by scanning the recording medium. A detector is provided in the carriage so as to detect a leading edge of the recording medium.

### TECHNICAL FIELD

The present invention generally relates to image forming apparatuses and, more particularly to an image forming apparatus that forms an image using an inkjet technique such as an inkjet recording apparatus.

### BACKGROUND ART

There is known an inkjet recording apparatus as an image forming apparatus (may be referred to as an image recording apparatus) such as a printer, a facsimile machine or a copy machine. The inkjet recording apparatus performs recording (image formation) by discharging droplets of ink from an inkjet recording head onto a recording medium, onto which droplets of ink can be adhered, such as a recording paper or an overhead projector (OHP) sheet. The inkjet recording apparatus has advantages in that a fine image can be recorded at high speed, a running cost is low, there is less noise, and a color image can be easily recorded by using multi-color ink.

In the inkjet recording apparatus, generally, a recording head that is means for forming an image is mounted on a carriage so as to form an image by moving the carriage while feeding a recording medium. In such an inkjet recording apparatus, it is important to acquire information regarding a position and a size of the recording medium. By acquiring positional information of the recording medium accurately, recording (image formation) can be started at an accurate position, which improves an image quality.

Especially in the inkjet recording apparatus using a conveyance belt to convey a recording medium, if droplets of ink are ejected from the recording head at a position out of the recording medium, the droplets of ink may landed onto the conveyance belt, which causes a problem in that a backside of the recording medium gets dirty.

Japanese Laid-Open Patent Application No. 2000-94782 discloses an inkjet recording apparatus having a sensor for measuring a length of a recording paper so as to detect a length of the recording paper along a direction of conveyance of the recording paper.

Moreover, conventionally, detection of a recording medium reaching an image forming part (recording part), that is generally referred to as a leading edge detection, is achieved by judging from an amount of conveyance of the recording medium or detecting a leading edge by a sensor located at a fixed position.

However, when the leading edge detection is performed in accordance with an amount of conveyance of the recording medium, it is difficult to accurately control the position of the recording medium since there is an influence of a physical error such as a fluctuation in setting of the recording medium or a positional shift of the recording medium during conveyance by a conveyance mechanism. Moreover, when the recording medium is detected by a sensor mounted at a fixed position, it is necessary to reserve the position of locating the sensor relative to sizes of the recording medium, which may give undesirable influence to a mechanical layout of the apparatus.

Additionally, there may be the same problem with respect to detection of a width of the recording medium. That is, when performing a recording operation in accordance with a print instruction sent from a personal computer, etc., and if an end of the recording medium is cut out or folded, there is a problem in that the recording operation is applied to a position where the recording medium does not exist since the recording operation is performed only in accordance with the print instruction sent from the personal computer. Further, there may occur a similar problem if the recording medium is conveyed in a slanting position, or an end of the recording medium is cut out. Thus, it is preferable to dynamically detect the width of the recording medium.

In the meantime, there are known various types of inkjet recording apparatus with respect to energy generating means for ejecting droplets of ink, such as a piezoelectric actuator type using a piezoelectric element, a thermal actuator type using a phase change caused by film boiling of a liquid by an electrothermal transforming element, a shape memory alloy actuator type using metal phase change caused by a temperature change, an electrostatic actuator type using an electrostatic force, etc. Generally, an inkjet recording apparatus, which forms an image by scanning a carriage having a recording head as a recording means mounted thereon, is provided with sensors that detect a position and velocity of the carriage so as to acquire a higher accuracy.

For example, Japanese Laid-Open Patent Application No. 2000-198244 discloses a recording apparatus having an encoder scale for detecting a position and moving velocity of a carriage and an encoder sensor. Additionally, Japanese Laid-Open Patent Application No. 2001-239704 discloses an apparatus having a carriage provided with light-emitting means for emitting an infrared light and light-receiving means for receiving the emitted infrared light so as to control a drive timing of recording head in accordance with the detection by the light-receiving means. Further, in an apparatus which forms an image by scanning a carriage having a recording head mounted thereon, an external environment is detected by a sensor mounted on a housing part which is not scanned during an image formation.

However, when a sensor is mounted on a housing part so as to detect an external environment or an internal environment of the apparatus, the result of detection by the sensor may differ from an environment surrounding the recording head, which may raise a problem that the result of detection includes an error inherently. Thereby, a drive waveform of the recording head may be changed or a drive current supplied to a drive means of a carriage may be changed in accordance with a change in an environment. However, there is a problem in that such a change cannot always be controlled with a sufficient accuracy.

Moreover, in an image forming apparatus which conveys a recording medium by a conveyance belt so as to maintain a flatness of the recording medium, especially when a rubber material, which has a thermal deformation larger than that of a metal, is used for a drive roller that drives the conveyance belt, an amount of travel of the conveyance belt may be fluctuated due to fluctuation of a diameter of the drive roller caused by temperature changes even if the rotational speed of the drive roller is constant. Thereby, accuracy of ink droplets may deteriorate, which causes a problem that an image quality is deteriorated or fluctuated.

Further, when a recording medium is conveyed using a conveyance belt, if droplets of ink adhere onto the conveyance belt, a backside of the recording medium may get dirty or leakage of charges on the conveyance belt may easily occur. If leakage occurs, the attraction force to the recording medium is reduced, which caused a problem that a normal conveyance cannot be performed.

In the meantime, Japanese Laid-Open Patent Application No. 7-179248 discloses a recording apparatus which performs an appropriate paper width detection according to a kind of recording paper by a paper width sensor provided in a carriage. Additionally, Japanese Laid-Open Patent Application No. 8-332738 discloses a recording apparatus which has an ink amount detection sensor for detecting an amount of ink stored in a waste ink storing part that is commonly used as a paper width sensor for detecting a width of a recording medium. Further, Japanese Laid-Open Patent Application No. 2002-301845 discloses a recording apparatus which detects a home position of a recording head by an optical sensor mounted on a carriage. Additionally, Japanese Laid-Open Patent Application No. 2001-10151 discloses a recording apparatus which is provided with a sensor for detecting a leading edge of a recording paper located on an upstream side of a feed roller that feeds the recording paper to a recording head, and also provided with a sensor for detecting a trailing edge of the recording paper mounted on a carriage having the recording head mounted thereon. Further, Japanese Laid-Open Patent Applications No. 5-131729 and No. 6-30933 disclose a recording apparatus provided with a paper sensor in a carriage for detecting a presence of a recording paper so as to detect the same position as a recording head in a paper feeding direction so that the sensor detects both a width and a trailing edge of the recording paper. Further, Japanese Laid-Open Patent Application No. 2002-265118 discloses an image forming apparatus which is provided with a paper sensor that detects a leading edge and/or a trailing edge of a recording paper near an inlet of a conveyance roller that conveys the recording paper.

As mentioned above, in an apparatus forming an image on a recording medium by scanning the recording medium in a main-scanning direction and a sub-scanning direction perpendicular to the main-scanning direction, there are known many apparatuses which detect a width and position of a recording medium (recording paper) by providing an optical sensor on a carriage or a home position (initial position) of the carriage. However, each of the conventional image forming apparatuses merely detects a position of a recording medium or a home position of a carriage by an optical sensor provided on the carriage. Accordingly, it is difficult to acquire detailed information as to where the recording medium is located on the conveyance path, or it is difficult to distinguish a kind of recording medium (regular paper, glossy paper or OHP sheet). Thereby, it is difficult to optimize various controls due to difference in recording media.

Further, when conveying a recording medium using a conveyance belt, if droplets of ink adhere onto the conveyance belt, a backside of the recording medium may get dirty or leakage may occur in a charge on the conveyance belt. If leakage occurs, an attraction force to the recording medium is reduced, which prevents the conveyance from being normally performed. However, the conventional image forming apparatus cannot deal with such a problem. Additionally, since the conventional apparatuses merely detect a presence of a recording medium by an optical sensor, it is difficult to acquire sufficient information from outside the recording medium.

As mentioned above, in an image forming apparatus which records an image by ejecting ink droplets, it is important to acquire accurate information regarding a recording medium onto which the ink droplets are landed. Especially, in an apparatus, which conveys a recording medium by a conveyance belt so as to improve flatness of the recording medium during conveyance, if ink droplets are ejected from a recording head toward a position outside the recording medium, the ink droplets land onto the conveyance belt. Therefore, there is a problem in that a backside of the recording medium may get dirty or an electrostatic attraction force to the recording medium by the conveyance belt may decrease.

### DISCLOSURE OF THE INVENTION

It is a general object of the present invention to provide an image forming apparatus in which the above-mentioned problems are eliminated.

A more specific object of the present invention is to provide an image forming apparatus which can detect a leading edge and a width of a recording medium with a simple structure so as to prevent erroneous recording.

Another object of the present invention is to provide an image forming apparatus which can perform an accurate control of conveyance of a recording medium by detecting a state of an interior or a surrounding area of a carriage having a recording head.

A further object of the present invention is to provide an image forming apparatus which can perform an accurate control of conveyance of a recording medium by dynamically detecting a state of an interior or a surrounding area of a carriage having a recording head.

Yet another object of the present invention is to provide an image forming apparatus which can control ejection of droplets so as to prevent the droplets from being landed onto a position outside a recording medium.

In order to achieve the above-mentioned objects, there is provided according one aspect of the present invention an image forming apparatus that forms an image on a recording medium, comprising: a carriage having a recording head to form the image by scanning the recording medium; and a detector provided in the carriage so as to detect a leading edge of the recording medium.

According to the above-mentioned invention, since the detector that detects a leading edge or a width of a recording medium is provided on the carriage, the detection of the leading edge or width of the recording medium can be achieved with a simple structure, and erroneous recording can be prevented.

The image forming apparatus according to the present invention may further comprise an analog processing circuit that transmits an output signal of the detector. Alternatively, the image forming apparatus according to the present invention may further comprise a digital processing circuit that transmits an output signal of the detector.

Additionally, in the image forming apparatus according to the present invention, the detector may be located at a position where the recording medium is detectable on an upstream side of an image formation start position by the recording head in a direction of conveyance of the recording medium, and also located on a side of an image forming area when the carriage is located at a home position.

There is provided according to another aspect of the present invention an image forming apparatus that forms an image on a recording medium, comprising: a carriage having a recording head to form the image by scanning the recording medium; and a detector provided in the carriage so as to detect a width of the recording medium in a direction of scanning.

The image forming apparatus according to the above-mentioned invention may further comprise an analog processing circuit that transmits an output signal of the detector. Alternatively, the image forming apparatus according to the present invention may further comprise a digital processing circuit that transmits an output signal of the detector.

In the image forming apparatus according to the above-mentioned invention, the detector may detect the width of the recording medium only when scanning is performed first. Additionally, in the image forming apparatus according to the above-mentioned invention, the detector may be located at a position where the recording medium is detectable on an upstream side of an image formation start position by the recording head in a direction of conveyance of the recording medium, and also located on a side of an image forming area when the carriage is located at a home position.

Additionally, there is provided according to another aspect of the present invention an image forming apparatus that forms an image on a recording medium, comprising: a carriage having a recording head to form the image by scanning the recording medium; and a state detector that detects a state of an interior of the carriage or a state of an area surrounding the carriage, the state detector being mounted on the carriage.

According to the above-mentioned invention, the state detector, which detects a state of an interior of the carriage or a state of an area near the carriage, is provided in the carriage. Thus, a control that is based on a result of detection of the state of the interior of the carriage or the area near the carriage can be performed with high accuracy.

In the above-mentioned image forming apparatus, the state detector may comprise an optical sensor having a light-emitting element emitting a light and a light-receiving element receiving the light emitted from the light-emitting element. The light-emitting element and the light-receiving element may be integrated with each other.

The image forming apparatus according to the above-mentioned invention may further comprise a conveyance belt that conveys the recording medium. The image forming apparatus according to the above-mentioned invention may further comprise a control part that determines whether the conveyance belt is dirty in accordance with a result of detection of the state detector. The state detector may comprise an infrared light sensor. Alternatively, the state sensor may comprise a temperature sensor that detects a temperature of an area surrounding the carriage.

The above-mentioned image forming apparatus may further comprise: a conveyance belt that conveys the recording medium; a drive roller that drives the conveyance belt; and a control part that corrects an amount of rotation of the drive roller in accordance with a result of detection of the state detector.

The above-mentioned image forming apparatus may further comprise a control part that changes a drive waveform applied to the recording head in accordance a result of detection of the state detector.

The above-mentioned image forming apparatus may further comprise: a drive part that drives the carriage; and a control part that changes a drive waveform applied to the drive part in accordance with a result of detection of the state detector.

Additionally, there is provided according to another aspect of the present invention an image forming apparatus that forms an image on a recording medium, comprising: a carriage having a recording head to form the image by scanning the recording medium; and a state detector including an optical sensor that is mounted on the carriage so as to detect a state of an area surrounding the carriage.

According to the above-mentioned invention, since the state detector includes the optical sensor provided in the carriage so as to detect a state of an area near the carriage, an optimum control can be performed in accordance with a result of detection of the optical sensor.

In the image forming apparatus according to the above-mentioned invention, the state detector may determine a kind of the recording medium in accordance with a result of detection of the optical sensor. Additionally, the kind of the recording medium may be determined in accordance with an analog output level of the optical sensor.

The image forming apparatus according to the above-mentioned invention may further comprise a conveyance member that conveys the recording medium by attaching the recording medium to a predetermined area of the a surface of the conveyance member, and wherein the state detector may detect a state of the surface of the conveyance member. The conveyance member may be an endless conveyance belt. Additionally, the state detector may detect blot on the conveyance belt in accordance with a result of detection of the optical sensor. Further, the state detector may detect damage on the conveyance belt in accordance with a result of detection of the optical sensor.

In the image forming apparatus according to the above-mentioned invention, component parts other than a conveyance part, which is present within a detectable area of the state detector so as to convey the recording medium, may have color density levels different from a color density level of the recording medium being conveyed by the conveyance part. Additionally, the color density levels of the component parts other than the conveyance part may be different from a color density level of the conveyance part.

Additionally, there is provided according to another aspect of the present invention an image forming apparatus that forms an image on a recording medium, comprising: a carriage having a recording head to form the image by scanning the recording medium; an optical sensor that is mounted on the carriage; and component parts other than a conveyance part, which is present within a detectable area of the optical sensor so as to convey the recording medium, having color density levels different from a color density level of the recording medium being conveyed by the conveyance part. The color density levels of the component parts other than the conveyance part may be different from a color density level of the conveyance part.

Additionally, there is provided according to another aspect of the present invention an image forming apparatus comprising: a carriage having a recording head that ejects droplets of liquid onto a recording medium for forming an image on the recording medium; and a state detector that detects presence of the recording medium along a moving line of the carriage, wherein when moving the carriage in a main-scanning direction to perform a printing operation, a part of the printing operation is cancelled after the state detector detects non-presence of the recording medium.

In the image forming apparatus according to the above-mentioned invention, the state detector may be provided on an upstream side of the carriage in the main-scanning direction so as to cancel the part of the printing operation in the main-scanning direction after a position where non-presence of the recording medium is detected by the state detector in an initial scanning of the carriage for printing. Alternatively, the state detector may be provided on an upstream side of the carriage in the main-scanning direction so as to cancel the part of the printing operation in the main-scanning direction while detecting a position the recording medium is not present for each main-scanning of the carriage for printing.

In the image forming apparatus according to the above-mentioned invention, a plurality of heads may be provided in the recording head so as to eject droplets in a plurality of colors by being arranged in the main-scanning direction, and the main-scanning of the carriage is continued after non-presence of the recording medium is detected by the state detector so as to cancel a printing operation of each of the heads step-by-step while moving the carriage in the main-scanning direction. Additionally, an amount of movement of the carriage in the main-scanning direction and cancellation of the printing operations of the heads step-by-step are controlled, after the non-presence of the recording paper is detected, in accordance with information regarding an adjustment value of intervals between the heads.

In the image forming apparatus according to the above-mentioned invention, a plurality of nozzle trains may be provided in the recording head so as to eject droplets in a plurality of colors by being arranged in the main-scanning direction, and the main-scanning of the carriage is continued after non-presence of the recording medium is detected by the state detector so as to cancel a printing operation of each of the nozzle trains step-by-step while moving the carriage in the main-scanning direction.

In the image forming apparatus according to the above-mentioned invention, the carriage may be movable bidirectionally so as to perform bidirectional printing, and, when a part of the printing operation in one direction is cancelled, a part of the printing operation corresponding to an area where the printing operation is cancelled in the one direction is also cancelled in the printing operation in the other direction.

In the image forming apparatus according to the above-mentioned invention, the carriage may be movable bidirectionally so as to perform bidirectional printing, and, the state detector is provided on each side of the carriage in the main-scanning direction.

In the image forming apparatus according to the above-mentioned invention, the state detector may be provided on an upstream side of the carriage in a feed direction of the recording medium, and the printing operation is started after the state detector detects an edge of the recording medium while scanning the carriage in the main-scanning direction, and the state detector detects the edge of the recording medium for each min-scanning of the carriage so as to determine a position of the edge of the recording medium used in the printing operation of a subsequent line.

In the image forming apparatus according to the above-mentioned invention, a plurality of heads may be provided in the recording head so as to eject droplets in a plurality of colors by being arranged in the main-scanning direction, and the main-scanning of the carriage may be continued beyond the edge of the recording medium detected by the state detector so as to cancel the printing operation of the heads step-by-step.

In the image forming apparatus according to the above-mentioned invention, an amount of movement of the carriage in the main-scanning direction and cancellation of the printing operations of the heads step-by-step may be controlled, after each of the heads passes the edge of the recording medium, in accordance with information regarding an adjustment value of intervals between the heads.

In the image forming apparatus according to the above-mentioned invention, a plurality of nozzle trains may be provided in the recording head so as to eject droplets in a plurality of colors by being arranged in the main-scanning direction, and the main-scanning of the carriage may be continued beyond the edge of the recording medium detected by the state detector so as to cancel the printing operation of the nozzle trains step-by-step.

In the image forming apparatus according to the above-mentioned invention, the state detector may be provided at a position corresponding to the nozzle train closest to an edge off the recording head in the main-scanning direction.

Additionally, the image forming apparatus according to the above-mentioned invention may further comprise a conveyance belt that conveys the recording medium by electrostatically attracting the recording medium onto a surface of the conveyance belt.

Other objects, features and advantages of the present invention will become more apparent from the following detailed description when read in conjunction with the accompanying drawings.

### BRIEF DESCRIPTION OF THE DRAWINGS

FIG. 1 is a structural diagram of an inkjet recording apparatus, which is an example of an image forming apparatus according a first embodiment of the present invention;

FIG. 2 is a plan view of a part of the inkjet recording apparatus shown in FIG. 1;

FIG. 3 is a perspective view of the part of the inkjet recording apparatus shown in FIG. 2;

FIG. 4 is a block diagram of an entire control part of the inkjet recording apparatus shown in FIG. 1;

FIG. 5 is a flowchart of a process performed by a control part;

FIG. 6 is a plan view of a part provided with a photosensor;

FIG. 7 is a plan view of the part provided with the photosensor;

FIG. 8 is a plan view of a part provided with the photosensor at different position;

FIG. 9 is a circuit diagram of a circuit when a reflective photosensor is used;

FIG. 10 is a graph of an output signal from the reflective photosensor shown in FIG. 9;

FIG. 11 is a graph showing variation in the output signal due to a difference in reflection coefficient of recording papers;

FIG. 12 is a circuit diagram of another example of the circuit using the reflective photosensor;

FIG. 13A is a plan view of a part provided with the photosensor for explaining detection of a width of a recording paper;

FIG. 13B is a graph showing a change in a sensor output signal voltage with respect to time;

FIG. 14 is a structural diagram of an inkjet recording apparatus, which is an example of an image forming apparatus according a second embodiment of the present invention;

FIG. 15 is a block diagram of an entire control part of the inkjet recording apparatus shown in FIG. 14;

FIG. 16 is a flowchart of a dirt detecting process performed by the control part;

FIG. 17 is a flowchart of a temperature correction control process performed by the control part;

FIG. 18 is a graph showing drive waveform patterns used in the temperature correction control process;

FIG. 19 is a flowchart of a temperature correction control process of a feed amount performed by the control part;

FIG. 20 is a partially cut away perspective view of a housing accommodating a carriage and a guide member;

FIG. 21 is a part of an inkjet recording apparatus according to a third embodiment of the present invention;

FIG. 22 is a block diagram of a control part of the inkjet recording apparatus according to the third embodiment of the present invention;

FIG. 23 is a flowchart of a printing process performed by the inkjet recording apparatus according to the third embodiment of the present invention;

FIG. 24 is a flowchart of a process of detecting blot and/or damage on a surface of a conveyance belt in accordance with a result of detection of a state detection sensor;

FIG. 25 is a bottom view of a recording head having a plurality of heads;

FIG. 26 is a bottom view of a recording head having a plurality of nozzle trains;

FIG. 27 is a flowchart of a first example of a print control performed by an inkjet recording apparatus according to the fourth embodiment of the present invention;

FIG. 28 is an illustration showing an example of printing;

FIG. 29 is an illustration showing an example of printing;

FIG. 30 is an illustration showing an example of printing when a print paper is slanted;

FIG. 31 is an illustration showing an example of printing;

FIG. 32 is a flowchart of a second example of a print control performed by an inkjet recording apparatus according to the fourth embodiment of the present invention;

FIG. 33 is an illustration showing an example of printing;

FIG. 34 is an illustration showing an example of printing;

FIG. 35 is a bottom view of a recording head having a plurality of heads;

FIG. 36 is an illustration showing an example of printing;

FIG. 37 is a flowchart of a third example of a print control performed by an inkjet recording apparatus according to the fourth embodiment of the present invention;

FIG. 38 is an illustration showing an example of printing;

FIG. 39 is an illustration showing an example of printing;

FIG. 40 is a bottom view of a carriage having two state detection sensors;

FIG. 41 is a bottom view of a carriage having a state detection sensor on an upstream side in a paper feed direction;

FIG. 42 is a flowchart of a print control performed by an inkjet recording apparatus having a state detection sensor on an upstream side of a carriage in a paper feed direction;

FIG. 43 is an illustration showing an example of printing; and

FIG. 44 is a bottom view of a carriage having a state detection sensor on an upstream side of a carriage in both a main-scanning direction and a paper feed direction.

### BEST MODE FOR CARRYING OUT THE INVENTION

A description will be given below of various embodiments of the present invention with reference to the accompanying drawings.

### FIRST EMBODIMENT

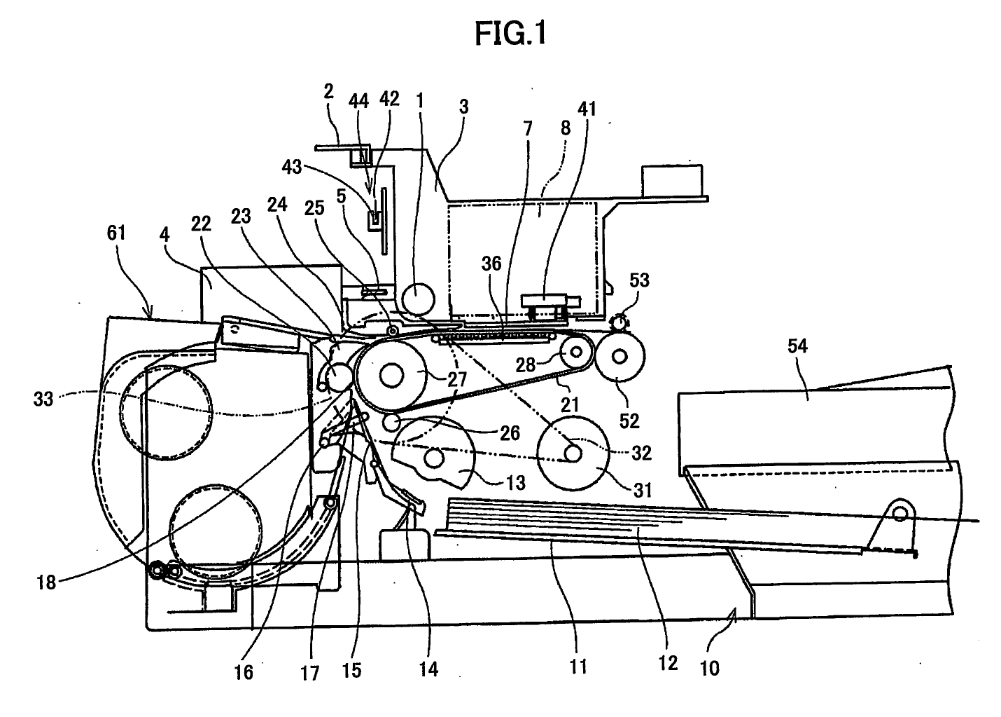

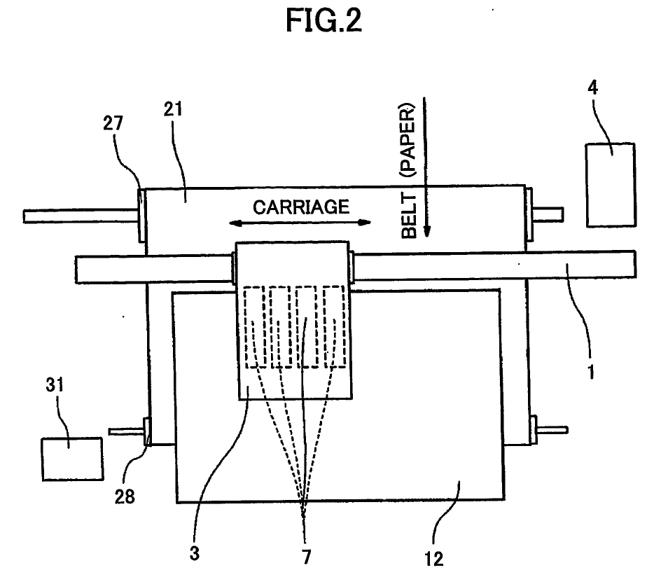

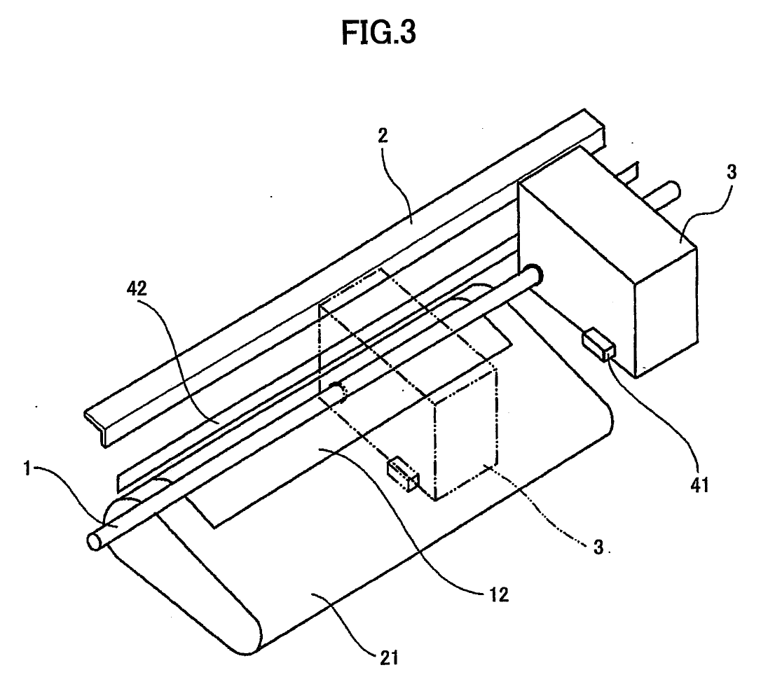

FIG. 1 is a structural diagram of an inkjet recording apparatus, which is an example of an image forming apparatus according a first embodiment of the present invention. FIG. 2 is a plan view of a part of the inkjet recording apparatus shown in FIG. 1. FIG. 3 is a perspective view of the part of the inkjet recording apparatus shown in FIG. 2.

The inkjet recording apparatus shown in FIG. 1 comprises a guide rod 1 and a guide rail 2 that together slidably support a carriage 3, which is movable in directions of arrows (main-scanning direction) in FIG. 2 by being driven by a main-scanning motor 4 via a timing belt 5. The guide rod 1 and the guide rail 2 are guide members bridging between left and right side plates (not shown in the figure) of the inkjet recording apparatus.

The carriage 3 is provided with a recording head 7 having four inkjet heads, which eject ink droplets of yellow (Y), cyan (C), magenta (M) and black (Bk) so that a plurality of ink outlet ports of the recording head 7 are arranged along a direction perpendicular to the main-scanning direction and the ink droplets are ejected in a downward direction.

The inkjet head constituting the recording head 7 may be of a piezoelectric actuator type using a piezoelectric element, a thermal actuator type using a phase change caused by film boiling of a liquid by an electrothermal transforming element, a shape memory alloy actuator type using metal phase change caused by a temperature change, an electrostatic actuator type using an electrostatic force, etc.

Sub-tanks 8 for each color are mounted on the carriage 3 so as to supply ink of each color to the recording head 7. Ink is supplied to each of the sub-tanks 8 from a main-tank (ink cartridge) through ink supply tubes (not shown in the figures).

A paper feed part, which feeds recording papers 12 placed on a paper placement part 11 of a paper supply cassette 10, comprises a woodruff roller (feed roller) 13 and a separation pad 14 that is urged toward the feed roller 13. The feed roller 13 separates and feeds the recording papers 12 from the paper placement part 11 on an individual recording paper basis. The separation pad 14 is made of a material having a high coefficient of friction. Additionally, there is provided, as a conveyance part for conveying the recording papers 12 fed from the paper feed part under the recording head 7, a conveyance belt 21, a counter roller 22, a conveyance guide 23 and an end press roller 25. The conveyance belt 21 conveys the recording papers 12 by attaching thereto by an electrostatic force. The counter roller 22 conveys each recording paper 12, which is fed from the paper feed part through a guide 15, by sandwiching each recording paper 12 with the conveyance belt 21. The guide 23 causes each recording paper 12 being fed upwardly to turn by about 90 degrees so that each recording paper 12 follows the conveyance belt 21. The end press roller 25 is urged toward the conveyance belt 21 by a press member 24. Additionally, a charge roller 26 is provided, which is charge means for electrically charging a surface of the conveyance belt so as to generate an electrostatic attraction force.

The conveyance belt 21 is an endless belt, which is engaged with a conveyance roller 27 and a tension roller 28 so as to be rotated in a direction in FIG. 2 (belt (paper) conveyance direction) by the conveyance roller 21 being rotated by a sub-scanning motor 31 via a timing belt 32 and a timing roller 33.

The conveyance belt 21 has a front layer and a back layer. The front layer is formed by a pure resin material, which has not been subjected to a resistance control and has a thickness of about 40 micron, such as, for example, an ETFE pure material. The front layer serves as a paper attracting surface. The back layer is formed of the same material as the front layer but is subjected to a resistance control by addition of carbon. The back layer may serve as an intermediate resistance layer or a grounding layer.

The conveyance roller 27 and the counter roller 22 together form a conveyance roller nip part 18. A paper detection sensor 16 is located at a predetermined position on an upstream side of the conveyance roller nip part 18 in the paper conveyance direction so as to detect each recording paper 12. The paper detection sensor 16 detects each recording paper 12 by a detection lever 17 being displaced by each recording paper 12. A position indicated by dotted lines in FIG. 1 indicates an ON position of the detection lever 17. It should be noted that the paper detection sensor 16 is provided for detecting each recording paper 12 being fed.

The charge roller 26 is brought into contact with the conveyance belt 21 so as to be rotated by the movement of the conveyance belt 21. The charge roller 26 is applied with a pressing force of 2.5 N at each end of an axis thereof. The conveyance roller 27 also serves as a grounding roller, which is brought into contact with the intermediate resistance layer (back layer) of the conveyance belt 21.

A guide member 36 is located on the backside of the conveyance belt 21 corresponding to a print area by the recording head 4. An upper surface of the guide member 36 protrudes toward the recording head from a tangential line of the two rollers (the conveyance roller 27 and the tension roller 28) that support the conveyance belt 21. Accordingly, the conveyance belt 21 is lifted and guided by the upper surface of the guide member 36 in the print area.

In order to detect an end of each recording paper 12 being conveyed by the conveyance belt 21, there is provided a paper sensor 41 comprising a reflection-type photosensor, which is a detector or detection means, on the carriage 3 as shown in FIG. 3. The paper sensor 41 is located at a position on a side of a recording area or image forming area (on a side of the conveyance belt 21) when the carriage 3 is at a home position indicated by solid lines in FIG. 3.

An encoder scale 42 having slits formed therein is provided on a front side of the carriage 3, and an encoder sensor 43 comprising a transmission-type photo-sensor is provided on the front side of the carriage 3 so as to detect the slits of the encoder scale 42. The encoder scale 42 and the encoder sensor 43 constitute an encoder 44 that detects a position (position relative to the home position) of the carriage in the main-scanning direction.

Further, there are provided, as a paper eject part for ejecting the recording papers recorded by the recording head 7, a separation part for separating each recording paper 12 from the conveyance belt 21, paper eject rollers 52 and 53 and a paper eject tray for accommodating the rejected recording papers 12.

Additionally, a double-side paper feed unit 61 is detachably attached to a backside of the inkjet recording apparatus. The double-side paper feed unit 61 takes each recoding paper 12 returned by reverse rotation of the conveyance belt 21 and turns over the returned recording paper 12, and feeds the recording paper 12 to a position between the counter roller 22 and the conveyance belt 21.

In the inkjet recording apparatus having the above-mentioned structure, each recording paper 12 is separated and fed from the paper supply part, each recording paper 12 being fed upwardly in a vertical direction is guided by the guide 15, each recording paper 12 is conveyed while being sandwiched between the conveyance belt 21 and the counter roller 22, and, then, the end of each recording paper 12 is guided by the conveyance guide 23 and pressed against the conveyance belt 21 by the end press roller 25 so as to change the direction of conveyance by about 90 degrees.

At this time, an alternating voltage is applied to the charge roller 26 from a high-voltage source by a control circuit (not shown) so that a positive output and a negative output are repeatedly applied to the charge roller 26. Thus, the conveyance roller 21 is charged in an alternating charge voltage pattern so that plus and minus charges are alternately arranged in the sub-scanning direction, which is a rotational direction of the conveyance belt 21. When the recording paper 12 is fed onto the conveyance belt 21, which is charged in the alternating plus and minus pattern, polarization charge occurs in the recording paper 12 so as to form charges opposite to the charge pattern of the conveyance belt 21. Thereby, the recording paper 12 is conveyed by the conveyance belt 21 rotating in the sub-scanning direction.

Thus, recording of one line is performed by ejecting ink droplets onto the recording paper 12, when the recording paper is stopped, by driving the recording head 7 in accordance with image signals while moving the carriage 3, and, then, recording of a next line is performed after conveying the recording paper by a predetermined distance. Upon receipt of a recording end signal or a signal which indicates that a trailing edge of the recording paper 12 reached the recording area, the recording operation is ended, and the recording paper 12 is ejected onto the paper eject tray 44.

In a case of double-side print, the conveyance belt 21 is reversed after completion of the recording of a front side (surface printed first) so as to send the recorded recording paper 12 to the double-side paper feed unit 61. Thereafter, the recording paper 12 is turned over (set the backside to be a surface to be printed) and is fed to a position between the counter roller 22 and the conveyance belt 21. Then, recording of the backside is performed by conveying the recording paper 12 to the conveyance belt 21 while performing a timing control, and, thereafter the recording paper 12 is ejected onto the paper eject tray 44.

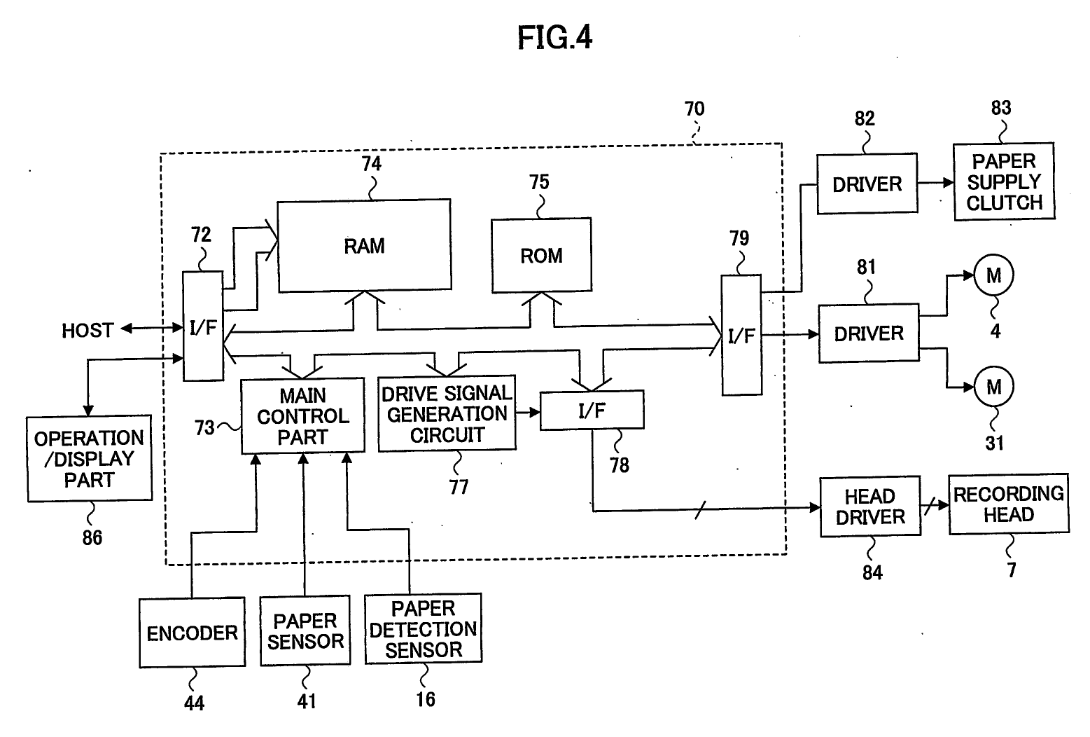

A description will now be given, with reference to FIG. 4, of a control part of the inkjet recording apparatus. FIG. 4 is a block diagram of the entire control part of the inkjet recording apparatus shown in FIG. 1.

The control part comprises: a printer controller 70; a motor driver 81 for driving the main-scanning motor 4 and the sub-scanning motor 31; a driver 82 for transmitting the drive force of the sub-scanning motor 31 to the feed roller 13; and a head driver 84 that comprises a head drive circuit, a driver IC, etc., for driving the recording head 7 (inkjet head).

The printer controller 70 comprises: an interface (hereinafter, abbreviated as I/F) 72 that receives print data and command signals through a cable or a network from an information processing apparatus such as a personal computer, an image reading apparatus such as an image scanner and an image taking apparatus such as a digital camera; a main control part 73 comprising a central processing unit (CPU); a random access memory (RAM) 74 for storing various kinds of data; a read only memory (ROM) 75 for storing programs for processing various kinds of data; a drive signal generating circuit 77 that generates a drive waveform to the recording head 7; an interface (I/F) 78 for sending to a head driver 84 the drive waveform and the print data developed into dot-pattern data (bit-map data); and an interface (I/F) 79 for sending the motor drive data to a motor driver 81 and for sending a clutch ON signal to a driver 82.

The RAM 74 is used as a buffer for various data and also as a work memory. The ROM 75 stores various control programs executed by the main control part 73, font data, graphics functions and various procedures.

The main control part 73 performs a paper feed control based on the detection signal from the paper detection sensor 16. Moreover, the main control part 73 detects a position of the a carriage 3 in the main-scanning direction based on the output signal of the encoder 44 so as to perform a stop position control of the carriage 3, and also detects a position of a leading edge of the recording paper 12 and presence of the recording paper 12 on the conveyance belt 21.

The main control part 73 reads and analyzes print data stored in a receiver buffer included in the I/F 72, and stores the results of analysis (intermediate code data) in a predetermined area of the RAM 74. Then, the main control part 73 generates dot-pattern data to be output as an image by using font data stored in the ROM 75 in accordance with the stored results of analysis, and stores the dot-pattern data in a different area in the RAM 74. It should be noted that, when transferring the image data to the recording apparatus after developing the image data into the bit-map data by a printer driver of a host side, the received bit-map image data is merely stored in the RAM 74.

The main control part 73, after acquiring dot-pattern data corresponding to one line of the recording head, sends the dot-pattern data as serial data corresponding to one line to the head driver 84 through the I/F 78 in synchronization with a clock signal CLK from an oscillation circuit 76, and sends a latch signal to the head driver 84 at a predetermined timing.

The drive signal generation circuit 77 consists of a ROM which stores a drive waveform (drive signal) and an amplifier and a waveform generation circuit including D/A converter which converts the drive waveform data read from the ROM. The ROM may be constituted by the ROM 75.

The head driver 84 comprises: a shift register which inputs the clock signal and the serial data, which is serial data, sent from the main control part 73; a latch circuit which latches a register value of the shift register by a latch signal from the main control part 73; a level conversion circuit (level shifter) which carries out level change of the output value of the latch circuit; and an analog switch array (switch means) which is turned on and off by the level shifter. The head driver 84 selectively applies a desired drive waveform contained in the drive waveform to the recording head 7 by controlling on/off of the analog switch array.

It should be noted that the printer controller is capable of exchanging instruction information and display information with an operation/display part 86 through the I/F 72.

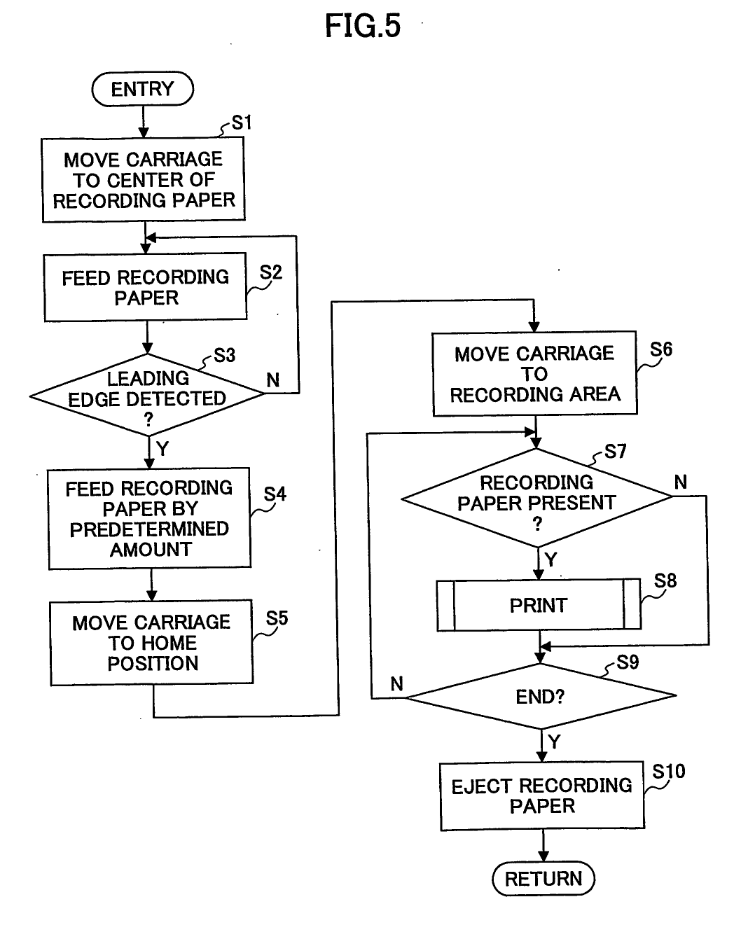

A description will now be given, with reference to FIG. 5 through FIG. 7, of a print control performed by the main control part 73.

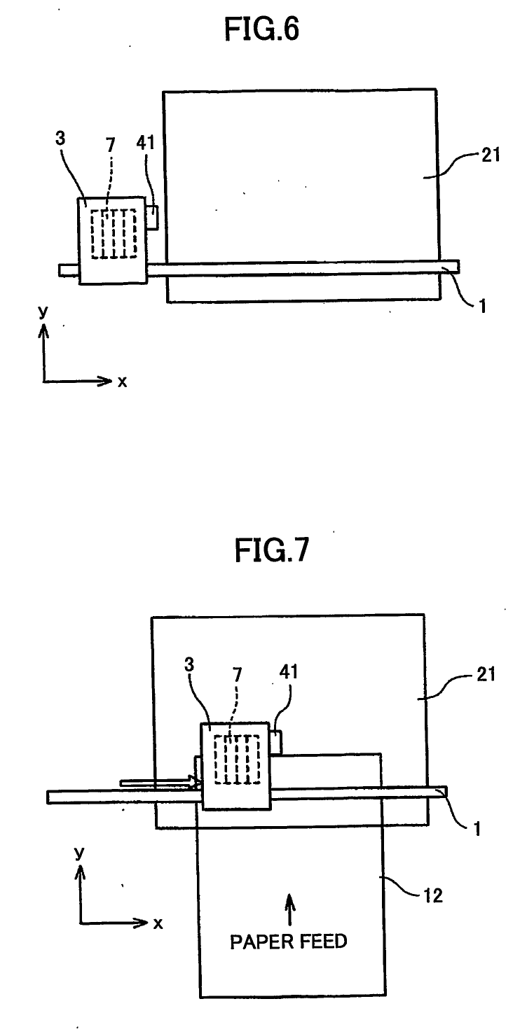

First, in step S1, the main control part 73 drives the main-scanning motor 4, prior to paper feed, so as to move the carriage 3 at a non-recordable position as shown in FIG. 6 in a direction indicated by an outline arrow to a center part of the conveyance belt 21 (or a center of a recording paper to be fed). Then, in step S2, the main control part 73 turns on the paper supply clutch so as to transmit the drive force of the sub-scanning motor 31 to the feed roller 13. Thereby, the feed roller 13 makes one turn in a clockwise direction, and the recording papers 12 are separated by the friction pad 14 and fed from the paper supply tray 10.

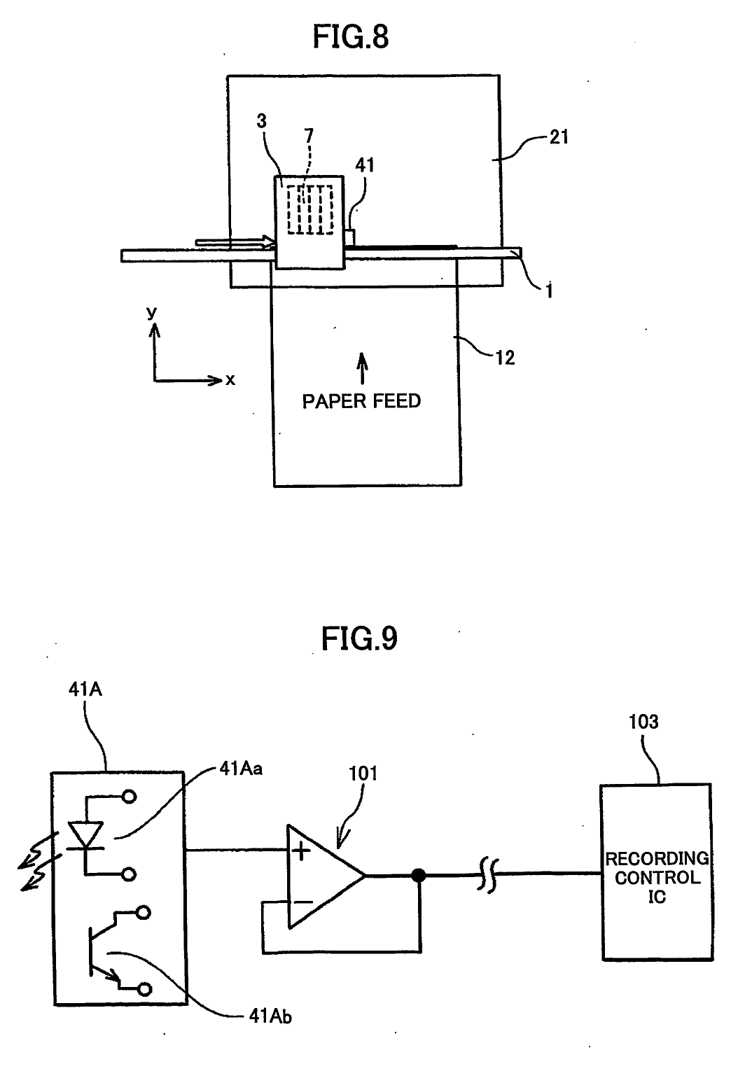

Then, the main control part 73 determines, in step S3, whether or not a leading edge of the recording paper 12 is detected by checking the detection signal of the paper sensor 41. After the leading edge of the recording paper 12 is detected, the recording paper 12 is conveyed, in step S4, to a print start position and stopped there. It should be noted that, in this case, as shown in FIG. 8, if the paper sensor 41 is located at a position at which the leading edge of the recording paper 12 can be detected on an upstream side of the print area (image forming area) in the conveyance direction, the recording paper 12 can be surely moved to the print start position if a detection position error occurs in the detection of the leading edge of the recording paper 12. Thus, there is no case happen that erroneous printing is performed on the conveyance belt 21 even when the printing is started from the leading edge of the recording paper 12.

Thereafter, in step S5, the carriage 3 is returned temporarily to the home position, and starts moving the carriage 3 toward the recording area in accordance with the output of the encoder 44. At this time, the main control part 73 determines, in step S7, whether or not there is a recording paper 12 by checking the detection signal of the paper sensor 41. If there is a recording paper 12, desired printing (recording operation) is performed in step S8. If no recording paper 12 is detected, the recording operation is not performed.

Then, it is determined, in step S9, where the printing operation is ended. If the printing operation is not ended, the routine returns to step S7 to resume the printing operation. Otherwise, the routine proceeds to step S10 so as to eject the recording paper 12, and the printing process is ended.

Thus, printing (ejection of ink droplets) is not performed at a position where there is no recording paper 12, that is, ink droplets are prevented from being ejected onto the conveyance belt 21, which prevents the conveyance belt 21 and the recording paper 12 from getting dirty.

A description will now be given of a process when using a reflective photosensor as the paper sensor 41. The reflective photosonsor is an element which converts an amount of light into an output voltage. The reflective photosensor is mounted in a state where a sensor faces the recording paper so as to detect presence of the recording paper 12 by using a difference in amounts of reflected light due to a difference in reflectance between the conveyance belt 21 and the recording paper 12.

FIG. 9 shows a circuit diagram of a circuit when the reflective photosensor is used. In the circuit shown in FIG. 9, a recording paper 12 on the conveyance belt 21 is detected by the reflective photosensor 41A having a light-emitting element 41Aa and a light-receiving element 41Ab, and an electric signal (output signal) output from the reflective photosensor 41A to a recording control IC 103, which constitutes the printer controller 70 controlling a recording operation, through a voltage follower circuit 101.

That is, since the electric signal output from the sensor 41A is very small, the voltage follower circuit 101 is constituted by an operational amplifier having a high input impedance so as to stabilize an output level of the sensor 41A. Additionally, the sensor and the recording control IC 103 are distant from each other in many cases, and, thus, the voltage follower circuit is effective as a noise reduction means. In this case, the input of the recording control IC 103 is made to be capable of handling an analog signal, and an A/D converter is mounted inside thereof so as to perform an A/D conversion.

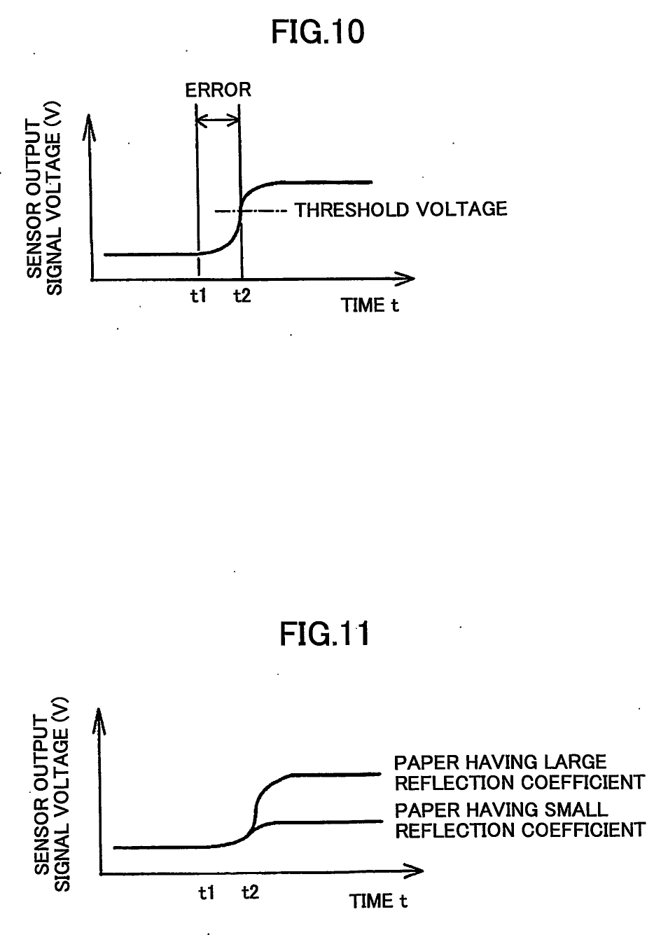

A description will be given advantages of transmitting the output signal of the sensor by an analog signal. FIG. 10 is a graph of the output signal from the reflective photosensor 41A. As shown in FIG. 10, it takes a certain time from a time when the recording paper 12 reaches a position corresponding to the sensor 41A until the output signal reaches a threshold voltage Vref at which the recording control IC 103 determines that recording paper is detected. Therefore, the accuracy of position detection varies depending on what voltage is set to the threshold voltage Vref.

Moreover, since a reflection coefficient varies depending on size of the recording paper, an amplitude of the voltage output from the photosensor 41A varies depending on the reflection coefficient as shown in FIG. 11. Therefore, by transmitting and processing the output signal of the sensor according to an analog method and setting the threshold voltage to a lower value, the accuracy of detection can be improved and an optimum threshold value can be set depending on kinds of recording paper.

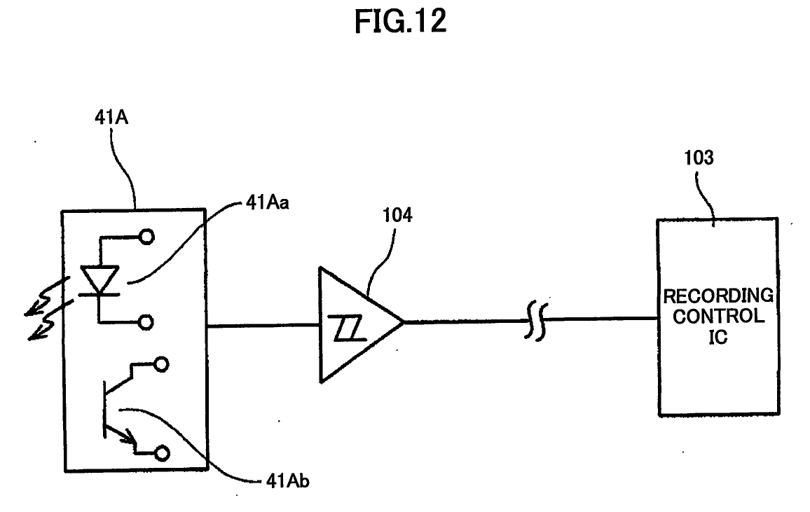

FIG. 12 is a circuit diagram of another example of the circuit using the reflective photosensor 41A. In the circuit structure shown in FIG. 12, the recording paper on the conveyance belt 21 is detected by the reflective photosensor 41A, and the electric signal (output signal) output from the reflective photosensor 41A is input to the recording control IC 103 through a buffer element 104 of a Schmidt Trigger input.

That is, the circuit structure shown in FIG. 12 is a digital processing circuit that transmits and processes the output signal of the photosensor according to a digital method. Although the output of the sensor 41A may be input directly to the recording control IC 103, a buffer element 104 is located near the sensor 41A so as to stabilize the output level of the sensor and reduce a noise. The buffer element 104 uses a C-MOS type having a high input impedance, and also a Schmidt Trigger input type having a hysteresis characteristic is used since the input is an analog signal.

By transmitting and processing the output signal according to a digital method, the circuit can be made at a low cost and prevented from being influenced by noises since the signal is transmitted by digital signal of “0” and “1”. Accordingly, as mentioned above, it is preferable to locate the buffer element near the sensor, for example, on the carriage.

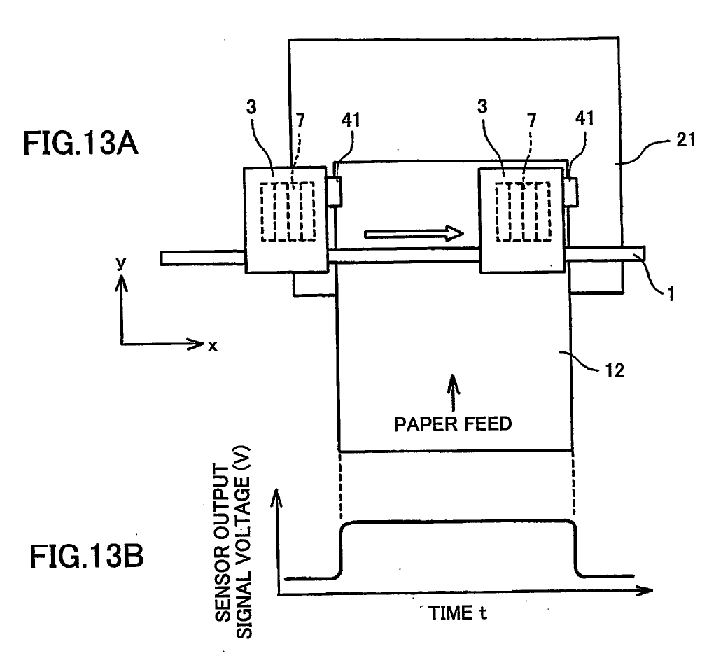

A description will now be given, with reference to FIGS. 13A and 13B, of detection of a width of a recording paper. Here, as mentioned above, after detecting a leading edge of the recording paper 12, the recording paper 12 is conveyed to a position where the sensor 41 can scan over the recording paper 12. Then, as shown in FIG. 13A, the carriage 3 is moved in the X-axis direction (main-scanning direction) so as to detect by the sensor 41 an area where the recording paper 12 is present. Since the output from the sensor 41 changes according to an output signal transition characteristic shown in FIG. 13B, and, thus, the width of the recording paper 12 can be detected by processing the output signal.

In this case, a circuit structure when using the reflective photosensor as the sensor 41 is that same as that shown in FIG. 9 or FIG. 12. Moreover, a load of the process of detection of the width of the recording paper can be reduced by performing the detection only one time after conveyance of the recording paper.

It should be noted that although the description was made of the embodiment in which the present invention is applied to the shuttle type inkjet recording apparatus using the carriage, the present invention is not limited to the inkjet recording apparatus. That is, for example, the present invention is applicable to a copy machine, a facsimile machine, a multifunction machine incorporating a copy apparatus, a printer and a facsimile apparatus.

### SECOND EMBODIMENT

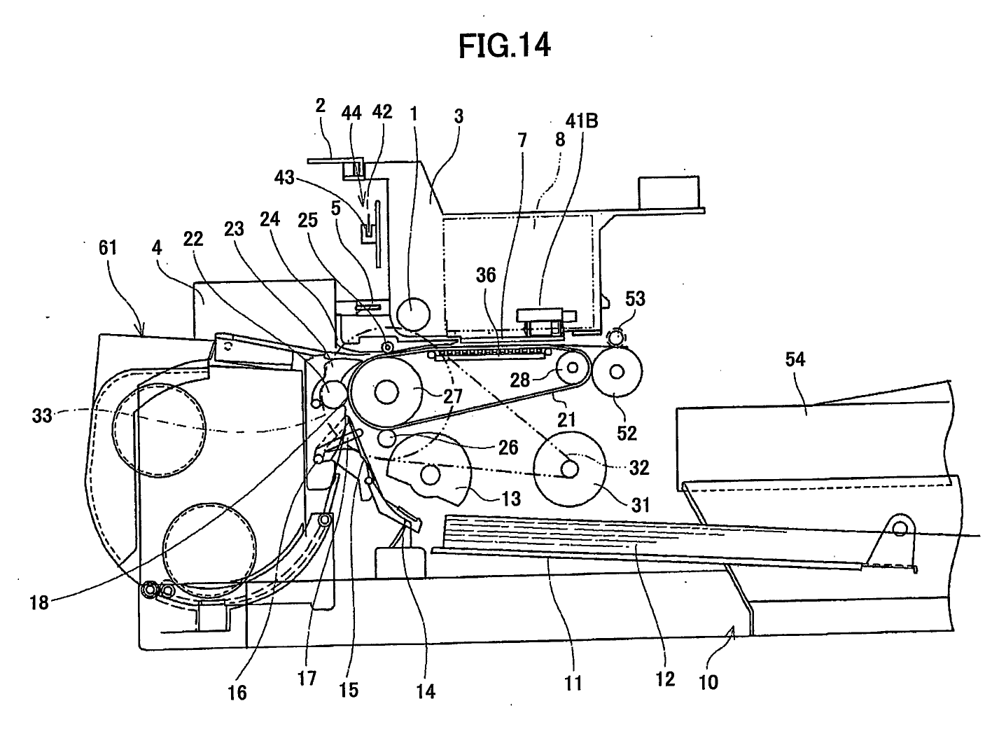

A description will now be given of an image forming apparatus according to a second embodiment of the present invention. FIG. 14 is a structural diagram of an inkjet recording apparatus, which is an example of the image forming apparatus according the second embodiment of the present invention. In FIG. 14, parts that are the same as the parts shown in FIG. 1 are given the same reference numerals, and descriptions thereof will be omitted.

The inkjet recording apparatus according to the second embodiment of the present invention has basically the same mechanical structure as the inkjet recording apparatus according to the above-mentioned first embodiment as shown in FIG. 1 except that a state sensor 41B, which serves as state detection means for detecting a state of an environment surrounding the recording head 7 or a surface of the conveyance belt 21, is mounted on the carriage 3, and descriptions of parts other than the state sensor 41B will be omitted.

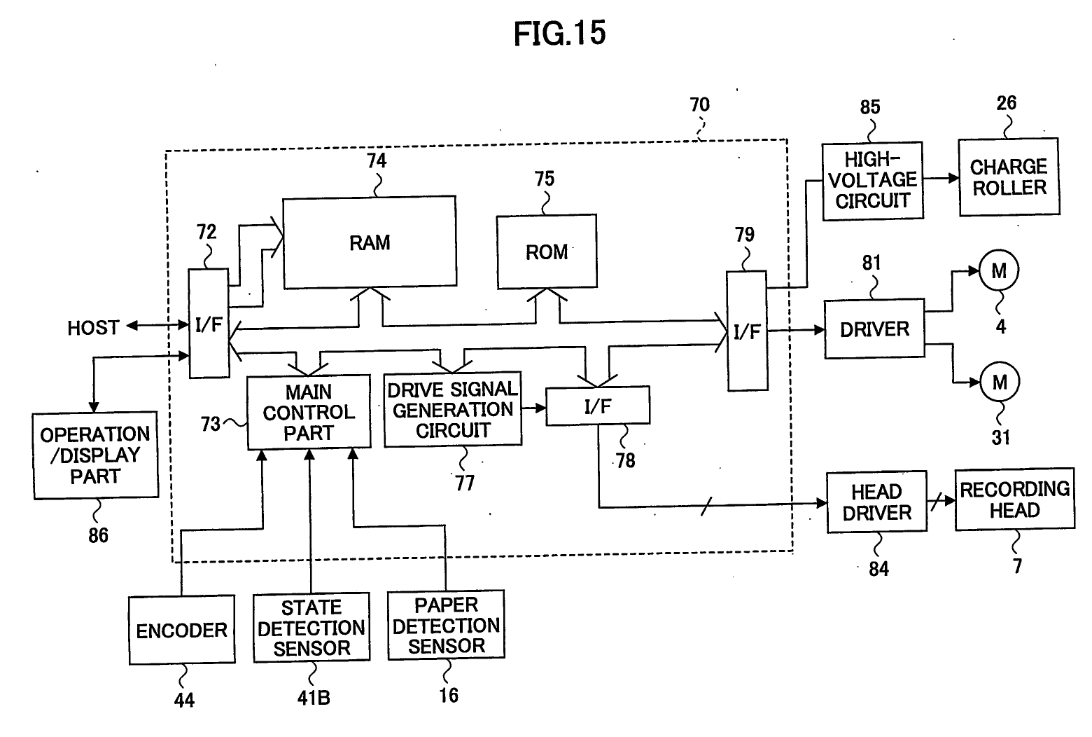

FIG. 15 is a block diagram of a printer controller 70A according to the second embodiment of the present invention. In FIG. 15, parts that are the same as the parts shown in FIG. 4 are given the same reference numerals, and descriptions thereof will be omitted. The printer controller 70A has the same structure as the printer controller 70 shown in FIG. 4 except for a driver 88 provided for applying a high-voltage to the charge roller 26.

A description will now be given of the state sensor 41B, which is a detector or detection means for detecting a state of an environment surrounding the recording head or a state of the surface of the conveyance belt 21.

First, a description will be given of an example of detecting dirt on the conveyance belt 21 by using an optical sensor as the state detection sensor 41B. A reflective photosensor having a light-emitting element and a light-receiving element integrally provided with each other is suitable for the optical sensor since such a reflective photosenosr has a simple construction. Additionally, such a reflective photosenosr is effective if the conveyance belt is made of an opaque material.

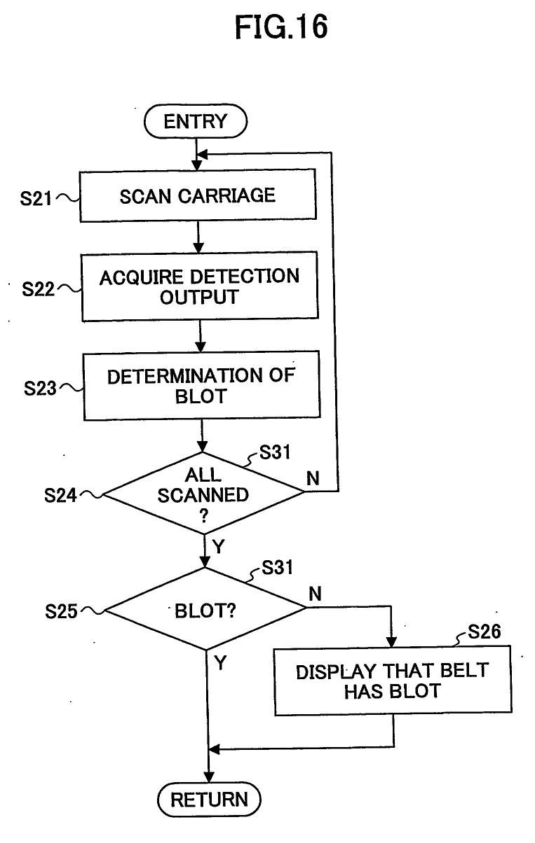

In this example, as shown in FIG. 16, the carriage 3 is moved, in step S21, to scan the surface of the conveyance belt 21 so as to acquire, in step S22, an output of the state detection sensor 41B in a state where the recording paper 12 is not conveyed by the conveyance belt 21. Then, a determination is made, in step S23, whether there is dirt on the conveyance belt 21. Thereafter, it is determined, in step S24, whether or not the entire surface of the conveyance belt 21 is checked. If the entire surface of the conveyance belt 21 is not checked, the routine returns to step S21. On the other hand, if it is determined that the entire surface of the conveyance belt 21 has been checked, the routine proceeds to step S25. Then, it is determined, in step S25, whether or not the conveyance belt 21 has blot. If it is determined that the conveyance belt 21 has blot, the routine proceeds to step S26 where the fact that the conveyance belt 21 has blot is displayed on the operation/display part 86 so as to notify a user that cleaning or replacement of the conveyance belt 21 is needed.

That is, if the surface of the conveyance belt 21 gets blot due to adhesion of ink droplets, a current may leak when charging the conveyance belt 21, which results in an insufficient electrostatic attraction force that causes a conveyance error of the recording paper 12. Or, the ink droplets on the conveyance belt 21 may be transferred onto a backside of the recording paper 12, which results in that the backside of the recording paper 12 gets blot. If double-side printing is performed on the recording paper, the blot on the backside of the recording paper cause deterioration of the image quality.

Thus, in order to eliminate the above-mentioned problem, if the conveyance belt 21 gets blot, a notification of generation of dirt is sent to a user so as to prevent the recording paper from being erroneously conveyed or getting blot.

Next, a description will be given of an example of detecting an environment by using an temperature sensor as the state detection sensor 41B. When an environmental temperature changes, viscosity of ink varies accordingly, which causes a change in an eject speed of ink droplets or a volume of each ink droplet may changes. Additionally, a diameter or a length of drive system structural members such as a timing belt and a wheel for driving the carriage 3 may changes, which cause a shift in a landing position of ink droplets due to fluctuation in the actually ejecting positions even when the eject timing according to the drive waveform is the same.

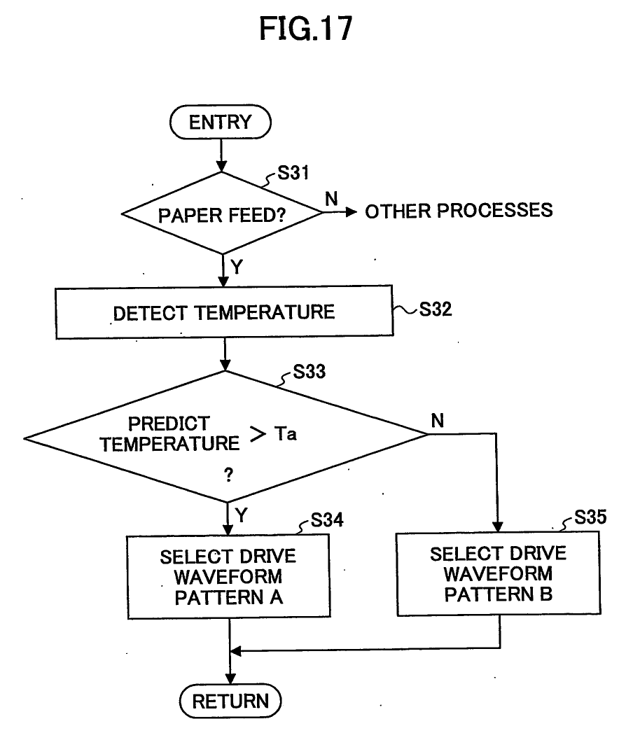

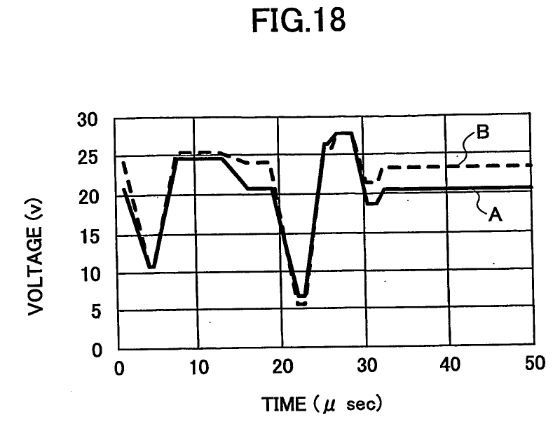

Thus, a process shown in FIG. 17 is performed. First, it is determined, in step S31, whether or not the recording paper 12 is fed. If the recording paper 12 is fed, the routine proceeds to step S32 where an environmental temperature is detected by the state detection sensor 41 using a temperature sensor. Then, it is determined, in step S33, whether or not the detected temperature is greater than a predetermined temperature Ta. If the detected temperature is greater than the predetermined temperature Ta, the routine proceeds to step S34 where a drive waveform pattern A shown in FIG. 18 is selected and the pressure generation means of the recording head 7 is driven according to the selected drive waveform pattern A. On the other hand, if the detected temperature is equal to or smaller than the predetermined temperature Ta, the routine proceeds to step S35 where a drive waveform pattern B shown in FIG. 18 is selected and the pressure generation means of the recording head 7 is driven according to the selected drive waveform pattern B.

Here, FIG. 18 shows examples of the drive waveform pattern. Specifically, FIG. 18 shows the drive waveform pattern A that is applied when the detected temperature exceeds the predetermined temperature (setting temperature) Ta and the drive form pattern B that is applied when the detected temperature does not exceed the predetermined temperature Ta. It should be noted that a plurality of setting temperatures may be set and also drive waveform patterns may be set in the similar manner, and the drive waveform pattern data may be stored in a memory.

Moreover, when a piezoelectric element, which is an electricity-to-mechanical force conversion element, is used as the pressure generation means of the recording head 7, the temperature compensation may be performed by differing the voltage value of the drive waveform pattern. That is, the temperature compensation can be easily performed by switching between different waveform patterns in accordance with the detected temperature. It should be noted that a thermal head or an electrostatic head can be used for the recording head 7, but these heads cannot be controlled by a simple parameter of the drive waveform such as a voltage value or a pulse width. On the other hand, the head using the piezoelectric element can set with a relatively large temperature compensation step width, and the temperature compensation can be easily performed. Thus, a memory capacity for the drive waveform data can be reduced, which reduces a capacity of the memory to store the drive waveform pattern data.

Moreover, although the drive waveform pattern data for temperature compensation is previously stored in memory means such as a ROM of the recording apparatus, the drive waveform pattern data may be transferred to the recording apparatus from a printer driver of a host side.

In such a case, since a temperature of an area closer to the recording head 7 is detected by the state detection sensor 41, a more accurate temperature compensation can be performed with respect to changes in the viscosity of ink.

Moreover, with respect to the carriage 3, a drive current corresponding to a temperature may be set so as to change the drive current supplied to the main-scanning motor 4 in response to the detected temperature. Also in such a case, since a temperature of an area closer to the carriage 3 is detected by the state detection sensor 41B, a more accurate temperature compensation can be performed with respect to changes in the scanning speed.

Furthermore, if a rubber roller or the line is used for the drive roller (conveyance roller) 27 which drives the conveyance belt 21 and when the environmental temperature changes, an amount of conveyances of the conveyance belt 21, that is, an amount of movement of the recording paper 12 is changed even when the rotation of the drive roller 27 is constant.

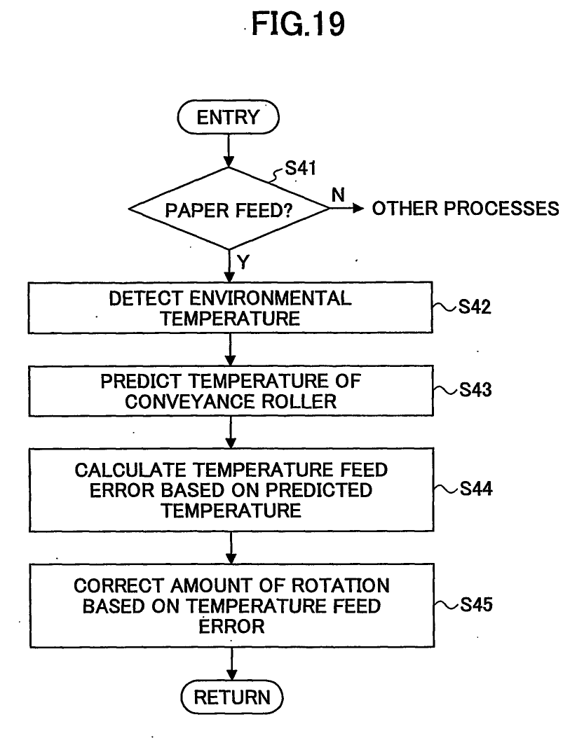

A description will be given below, with reference to FIG. 19, of a control process of an amount of conveyance by the conveyance roller in accordance with the detected temperature.

First, it is determined, in step S41, whether or not the recording paper 12 is fed. If the recording paper 12 is fed, the routine proceeds to step S42 where the main control part 73 detects an environmental temperature based on the detection signal of the state detection sensor 41B, which is a temperature sensor. Then, the main control part 73 performs a process for predicting a temperature of the conveyance roller 27 in accordance with the detected environmental temperature.

Subsequently, the main control part 73 calculates, in step S44, an amount of error (hereinafter, referred to as “temperature feed error”) in an amount of conveyance in accordance with the predicted temperature. Here, the calculation of the temperature feed error is performed by computing a temperature-correction coefficient KTC by the following equations (1) and (2).
K_{TC}=d/[d+k(t−23)] (1)
d=32.34×[(25.4+c×10⁻⁶+u×10⁻⁶)/25.4] (2)

It should be noted that, in the above-mentioned equations, “k” represents a temperature coefficient (=0.007 [mm/° C.]), “t” represents a detection temperature (predicted temperature), “d” represents a diameter of the conveyance roller (23° C.) , “c” represents a process correction value, and “u” represents a user correction value.

Then, in step S45, the main control part 73 corrects the amount of rotation of the conveyance roller 27 by multiplying the feed amount of the recording paper 12 by the obtained temperature-correction coefficient so as to control the rotation of the conveyance roller 27 in accordance with the corrected amount of rotation.

As mentioned above, by detecting a temperature that relates to the temperature of the conveyance roller 27 for each page and correcting the amount of rotation of the conveyance roller 27 based on the detected temperature, the fluctuation in the amount of feed of the recording paper due to temperature changes can be suppressed even when the conveyance roller 27 is made of a material such as rubber which tends to be influenced by the temperature changes, thereby achieving a stable image quality.

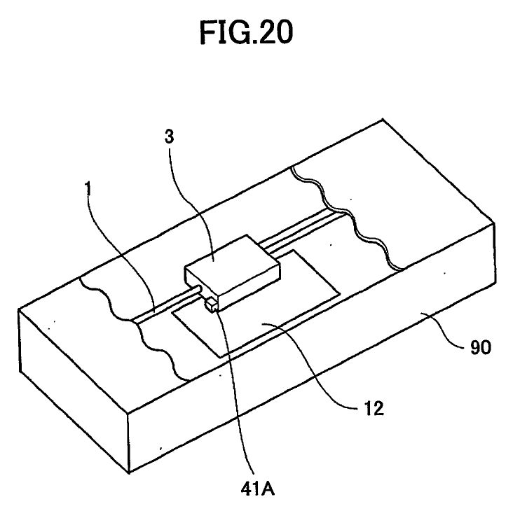

Next, a description will be given, with reference to FIG. 20, of a relationship between the apparatus main body including the carriage 3 and the sensor use as the state detection sensor 41B. In a normal image forming apparatus, as shown in FIG. 20, the carriage 3 and the guide member 1 are covered by a member or a housing 90 so as to be shielded from outside in order to prevent a user from contacting a moving part while the carriage 3 is moving. It should be noted that the carriage 3 and the guide member 1 are not completely shielded, but the shielding member may have an opening, a window or a lid.

If the carriage 3 is accommodated in the shielding member such as a housing as mentioned above, a high detection accuracy can be obtained by using an optical sensor as the state detection sensor 41B. Moreover, if a light toward the carriage 3 is not completed shut off, a more stable detection can be performed by using an infrared light sensor as the state detection sensor 41B.

### THIRD EMBODIMENT

A description will now be given of an ink inkjet recording apparatus, which is an example of an image forming apparatus according a third embodiment of the present invention.

The inkjet recording apparatus according to the third embodiment of the present invention has basically the same structure as the inkjet recording apparatus shown in FIG. 1, and description of the entire structure thereof will be omitted.

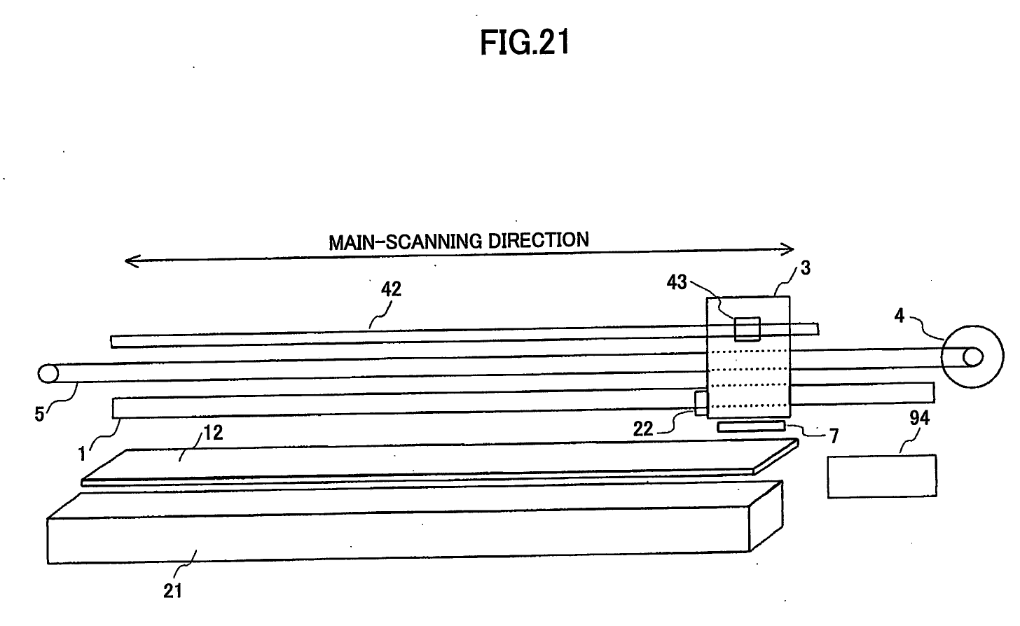

The inkjet recording apparatus according to the present embodiment has, in addition to the structure of the inkjet recording apparatus shown in FIG. 1, a maintenance and recovery mechanism 94, as shown in FIG. 21, so as to maintain a state of nozzles of the recording head 7 and recover the state of the nozzles when it is deteriorated. The maintenance and recovery mechanism 94 is located in a non-recording area outside a recording area along the direction of movement of the carriage 3, as shown in FIG. 21. The maintenance and recovery mechanism 94 comprises a cap member, which caps a nozzles surface of the recording head 7, and a wiper blade, which wipes the nozzle surface.

A description will now be given, with reference to FIG. 21, of the control part of the inkjet recording apparatus according to the present embodiment. FIG. 21 is a block diagram of the control part 100 of the inkjet recording apparatus according to the present invention.

The control part 100 comprises: a control processing unit 101 which controls the entire apparatus; a read only memory (ROM) 102 which stores programs executed by the CPU 101 and various kinds of fixed data; a random access memory (RAM) 103 which temporarily stores image data and other data; a non-volatile memory (NVRAM) 104 which reserves data while a power of the apparatus is turned off; an application specification integrated circuit (ASIC) 105 which applies an image process to image data and processes input and output signals for controlling the entire apparatus; an I/F 106 through which signals are exchanged with a host side; a head drive control part 107 and a head driver 108 for controlling the recording head 7; a main-scanning motor drive part 109 which drives the main-scanning motor 4; and a sub-scanning motor drive part 110 which drives the sub-scanning motor 31.

The control part 100 is connected with an operation panel 101 though which information required for the apparatus is input and displayed. Additionally, the control part 100 is supplied with the detection signal from the above-mentioned state detection sensor provided in the carriage 3. The control part 100 receives through the I/F 106 print data, etc., from a host side apparatus including an information processing apparatus such as a personal computer, an image reading apparatus such as an image scanner, and an image taking apparatus such as a digital camera.

The CPU 101 reads and analyzes the print data in the receiving buffer provided in the I/F 86, and sends the print data to the head drive control part 107 after applying necessary image processing and data rearrangement by the ASIC 105. It should be noted that the dot pattern data for outputting an image may be performed by storing font data in the ROM 102. Alternatively, the image data is developed into bit map data by a printer driver of a host side, and the thus-prepared image data may be transferred to the inkjet recording apparatus.

Upon receipt of the image data (dot pattern data) corresponding to one line of the recording head 7, the head drive control part 107 sends the dot pattern data corresponding to one line to the head driver 108 in synchronization with a clock signal, and also sends a latch signal to the head driver 108 at a predetermined timing.

The head drive control part 87 comprises: a ROM (the ROM 102 may be used commonly) which stops pattern data of the drive waveform (drive signal); and a drive waveform generation circuit comprising an amplifier and a waveform generation circuit containing a D/A converter which converts drive waveform data read from the ROM into analog data.

The head driver 108 comprises: a shift register which inputs the clock signal and the serial data, which is image data, from the head drive control part 107; a latch circuit which latches a resister value of the shift register by the latch signal from the head drive control part 107; a level conversion circuit (level shifter) which carries out a level change of an output value of the latch circuit; and an analog switch array (switching means) which is controlled to be on/off by the level shifter. The head driver 108 drives the recording head 7 by selectively applying a desired drive waveform to the recording head 7 by controlling on/off of the analog switch array.

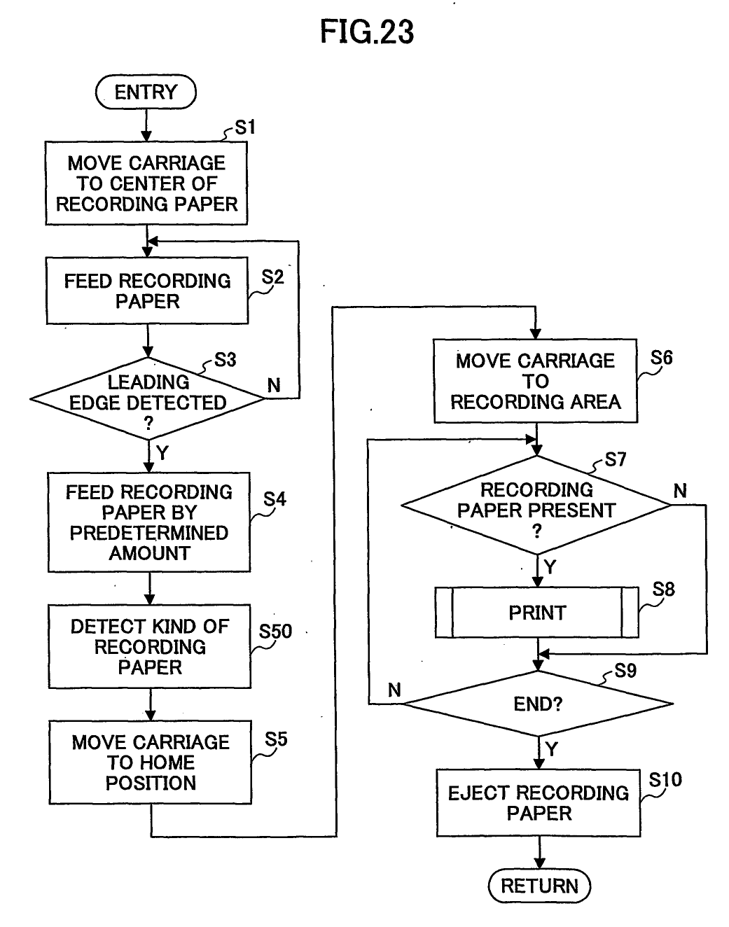

A description will now be given, with reference to FIG. 23, of a recording paper kind detection process by the control part 100 using the state detection sensor 41. FIG. 23 is a flowchart of a printing process including the recording paper kind detection process which detects a kind of the recording paper. In FIG. 23, steps that are the same as the steps shown in FIG. 5 are given the same step numbers, and descriptions thereof will be omitted.

The process shown in FIG. 23 is basically the same as the process shown in FIG. 5 except for step S50 provided between step S4 and step S5. When the printing process is started, the process of steps S1 through S4 shown in FIG. 5 is performed. Then, after performing the process of step S4, the routine proceeds to step S50.

In step S50, a kind of the recording paper 12 is determined (detected) based on the detection signal of the state detection sensor 41. As the recording medium used in the inkjet recording apparatus, there area mainly a regular paper, a glossy paper and an overhead projector (OHP) sheet. The regular paper is a widely used recording paper which is inexpensive but there occurs large bleeding or blot of ink. Although the glossy paper is more expensive than the regular paper, there is less bleeding or blot of ink, which permits a high-quality printing. The OHP sheet is used for preparing a presentation documents using a projector and is less frequently used than other recording papers, but there is no bleeding or blot or absorption of ink occurs.

As mentioned above, since the behavior of ink landed on a recording medium depends on a type or kind of the recording medium, normally, a printing characteristic is changed for each setting of a recording medium. In such a case, the setting of the recording medium is normally performed by a user using a host computer, and, thus, if the user make a mistake in setting, an appropriate image quality cannot be achieved. However, if a type or kind of the recording medium is automatically discriminated, an appropriate image can always be formed. In such a case, an analog output level of the state detection sensor 41 is used for the discrimination of the type or kind of the recording medium. That is, when an optical sensor is used, and on the assumption that a relationship between the recording media is, for example, regular paper<glossy paper<OHP sheet, the analog output levels output from the same optical sensor are in a similar relationship. Thus, by detecting a difference between the analog output levels, the discrimination of the recording media can be performed with high accuracy.

A description will be given below of an example of discrimination. The relationship between the analog output levels of the state detection sensor 41 and types or kinds of the recording paper are indicated in the following Table 1.

TABLE 1

| Sensor Output Level | Recording Medium |
|---|---|
| 0-1 V | None |
| 1-2 V | Regular Paper |
| 2-3 V | Glossy Paper |
| 4-5 V | OHP Sheet |

Thus, a type or kind of the recording paper 12 which is conveyed by the conveyance belt 21 can be detected by comparing the output of the state detection sensor 41 with reference levels set in accordance with the types or kinds of recording paper.

After the type or kind of the recording paper 12 is detected in step S50, the routine proceeds to step S5 through S10 so as to perform the printing process on the recording paper 12 as explained by referring to FIG. 5.

As mentioned above, an optimum print control suitable for the recording medium being currently conveyed can be performed by detecting the type or kind of the recording medium by providing a state detection sensor (state detector), especially, a reflective optical sensor, so as to detect a state of an area near the carriage 3. In this case, it becomes possible by performing detection of a kind of the recording medium in accordance with the analog output levels of the reflective optical sensor to discriminate the difference in the kind of recording medium accurately.

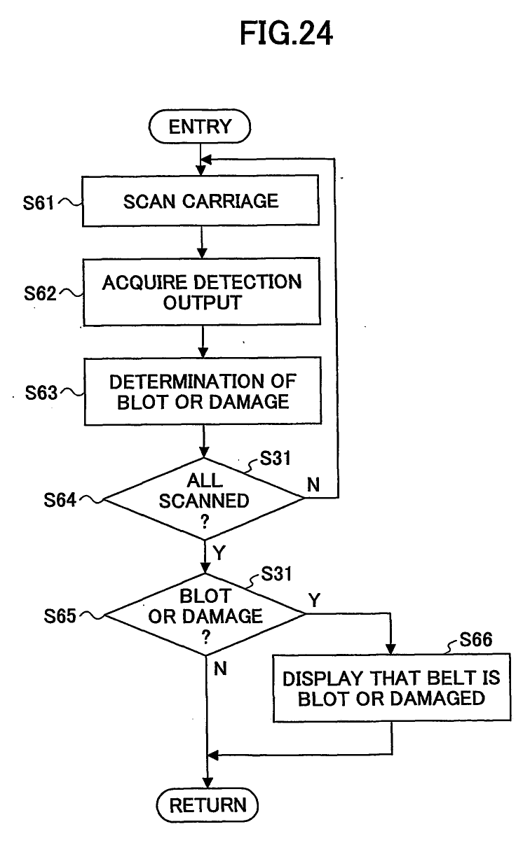

A description will now be given, with reference to FIG. 24, of a process of detecting blot and/or damage on the surface of the conveyance belt 21 in accordance with a result of detection of the state detection sensor 41.

As shown in FIG. 24, the carriage 3 is moved, in step S61, to scan the surface of the conveyance belt 21 so as to acquire, in step S62, an output of the state detection sensor 41 in a state where the recording paper 12 is not conveyed by the conveyance belt 21. Then, a determination is made, in step S63, whether there is blot or damage on the conveyance belt 21. Thereafter, it is determined,. in step S64, whether or not the entire surface of the conveyance belt 21 is checked. If the entire surface of the conveyance belt 21 is not checked, the routine returns to step S61. On the other hand, if it is determined that the entire surface of the conveyance belt 21 has been checked, the routine proceeds to step S65. Then, it is determined, in step S25, whether or not the conveyance belt 21 is blot or damaged. If it is determined that the conveyance belt 21 is blot or damaged, the routine proceeds to step S66 where the fact that the conveyance belt 21 is blot or damaged is displayed on the operation panel 111 so as to notify a user that cleaning or replacement of the conveyance belt 21 is needed.

That is, if the surface of the conveyance belt 21 gets blot due to adhesion of ink droplets or damaged for some reasons, a current may leak when charging the conveyance belt 21, which results in an insufficient electrostatic attraction force that causes a conveyance error of the recording paper 12. Or, the ink droplets on the conveyance belt 21 may be transferred onto a backside of the recording paper 12, which results in that the backside of the recording paper 12 gets blot. If double-side printing is performed on the recording paper, the blot on the backside of the recording paper causes deterioration of the image quality.

Thus, in order to eliminate the above-mentioned problem, if the conveyance belt 21 gets blot or damaged, a notification of generation of blot or damage is sent to a user so as to prevent the recording paper from being erroneously conveyed or getting blot.

If an optical sensor is used for the state detection sensor 41 as mentioned above and if a component part providing an amount of light the same as the recording medium within a range where the state detection sensor is movable, an erroneous detection of the recording medium may occur since the optical sensor outputs the detection signal corresponding to the amount of light provided by the component part.

Thus, within the range where the state detection sensor 41 is movable, component parts other than the conveyance belt 21, such as, for example, parts constituting the maintenance and recovery mechanism 94 are different in color density level from the recording medium 12. Thereby, the detection accuracy of the recording medium is improved.

Further, if the component parts other than the conveyance belt 21, such as, for example, parts constituting the maintenance and recovery mechanism 94 are different in color density level from the conveyance belt 21, the object of detection (recording medium) can be discriminated more accurately, which improves the detection accuracy especially when the conveyance means comprises the conveyance belt 21 and blot or damage of the conveyance belt 21 is detected by the optical sensor. It should be noted that in order to differ the color density level, the colors of the component parts may be made different from the colors of the recording medium and the component parts of the conveyance means.

### FOURTH EMBODIMENT

A description will now be given of an ink inkjet recording apparatus, which is an example of an image forming apparatus according a fourth embodiment of the present invention.

The inkjet recording apparatus according to the fourth embodiment of the present invention has basically the same structure as the inkjet recording apparatus shown in FIG. 1, and description of the entire structure thereof will be omitted.

The inkjet recording apparatus according to the present embodiment has, in addition to the structure of the inkjet recording apparatus shown in FIG. 1, a maintenance and recovery mechanism 94, as shown in FIG. 21, so as to maintain a state of nozzles of the recording head 7 and recover the state of the nozzles when it is deteriorated. The maintenance and recovery mechanism 94 is located in a non-recording area outside a recording area along the direction of movement of the carriage 3, as shown in FIG. 21. The maintenance and recovery mechanism 94 comprises a cap member, which caps a nozzles surface of the recording head 7, and a wiper blade, which wipes the nozzle surface.

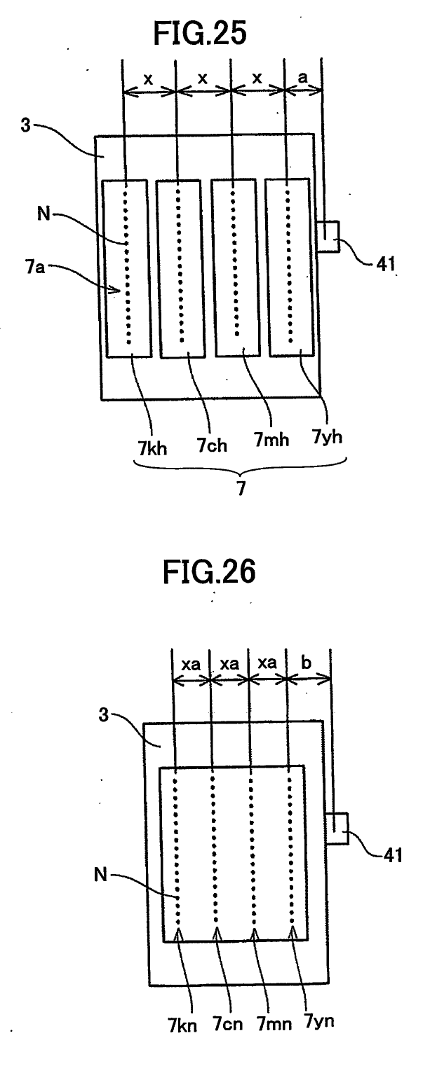

Moreover, as shown in FIG. 25, the recording head 7 includes four heads 7kh, 7ch, 7mh and 7yh mounted on the carriage 3. Each of the heads has a nozzle train 7a containing a plurality of nozzles N. The number of heads of the recording head 7 is not limited to four. The number of the nozzle train 7a in each head is not limited to one, and tow or more nozzle trains may by provided in each head. Alternatively, as shown in FIG. 26, the recording head 7 may have a plurality of nozzle trains 7kn, 7cn, 7mn and 7yn each of which has a plurality of nozzles N. The number of nozzle trains is not limited to four as shown in FIG. 26, and an arbitrary number of nozzle trains may be provided in the recording head 7.

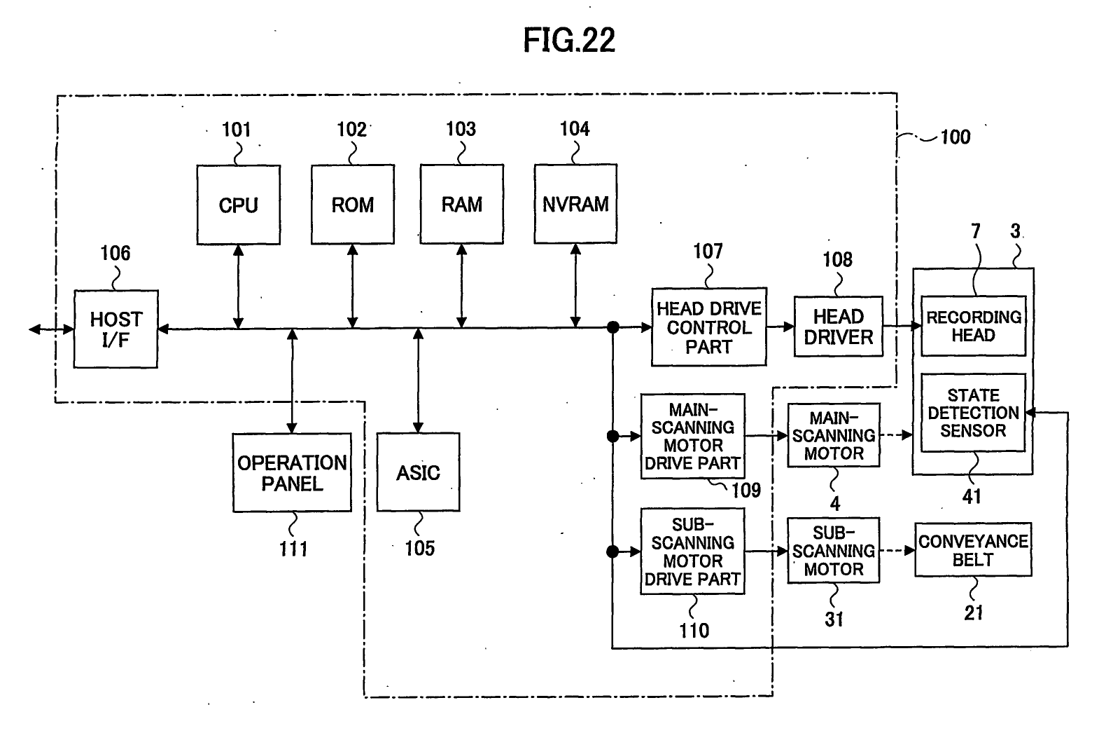

A control part of the inkjet recording apparatus according to the present embodiment has the same structure as the control part 100 of the inkjet recording apparatus according to the third embodiment as shown in FIG. 22, and description thereof will be omitted.

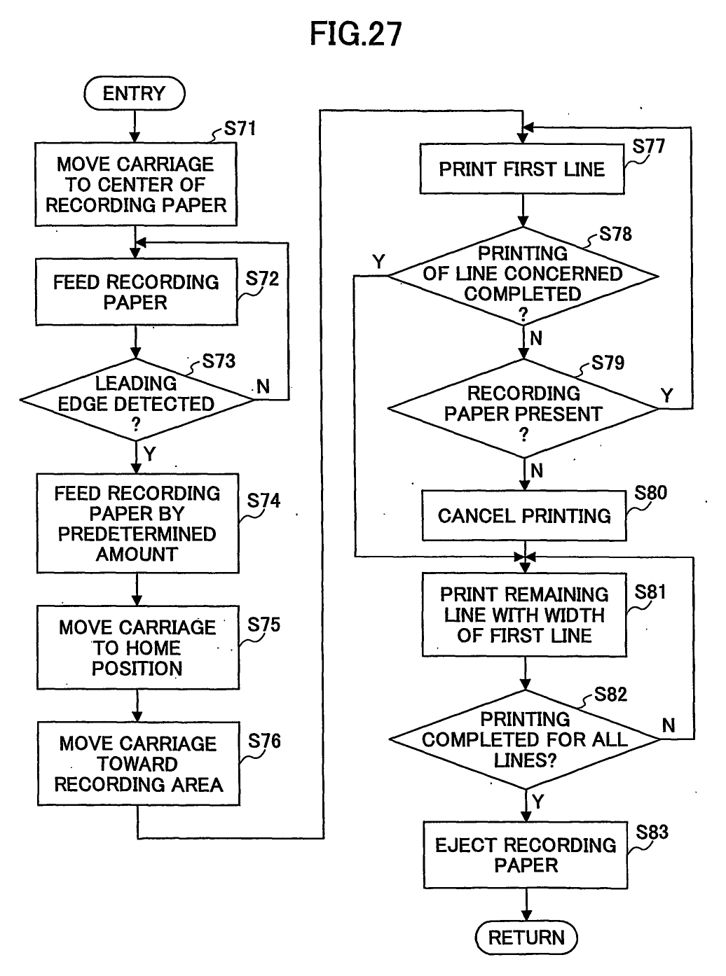

A description will now be given, with reference to FIG. 27, of a print control performed in the inkjet recording apparatus according to the present embodiment.

First, in step S71, the main-scanning motor 4 is driven, prior to paper feed, so as to move the carriage 3 at a non-recordable position in a direction indicated by an outline arrow to a center part of the conveyance belt 21 (or a center of a recording paper to be fed). Then, in step S72, the paper supply clutch is turned on so as to transmit the drive force of the sub-scanning motor 31 to the feed roller 13. Thereby, the feed roller 13 makes one turn in a clockwise direction, and the recording papers 12 are separated by the friction pad 14 and fed from the paper supply tray 10.

Then, it is determined, in step S73, whether or not a leading edge of the recording paper 12 is detected by checking the detection signal of the paper sensor 41. After the leading edge of the recording paper 12 is detected, the recording paper 12 is conveyed, in step S74, to a print start position and stopped there. Thereafter, in step S75, the carriage 3 is returned temporarily to the home position, and starts moving the carriage 3 toward the recording area in accordance with the output of the encoder 44.

Then, in step S76, the carriage 3 is moved toward the recording area, and a printing operation of a first line (an area printed by one scanning of the carriage 3) is started in step S77. Then, it is determined, in step S78, whether or not the printing operation is completed each time the carriage 3 has moved a predetermined amount (distance). If the printing operation is not completed, the routine proceeds to step S79 where it is determined whether or not the recording paper 12 is present by checking the detection signal of the state detection sensor 41.

Here, if there is the recording paper 12 to be printed, the scanning of the carriage 3 is continued so as to continue the printing of the line concerned. On the other hand, if there is no paper 12 (when the state detector 41 detects that there is no recording paper), the routine proceeds to step S80 where a printing operation after the line concerned is cancelled. Therefore, in such a case, the printing data of the line concerned is cleared. Thus, the printing operation is not performed in an area where there is no recording paper 12, which prevents ink droplets from being landed on the conveyance belt 21, and, thereby, the conveyance belt 21 and the recording paper 12 are prevented from being blot.

After the printing operation is cancelled in step S80, the line remaining is printed, in step S81 with the same width (width in the main-scanning direction) of the first line. Then, it is determined in step S82 whether or not the printing is completed for all lines. If the printing is completed for all lines, the routine proceeds to step S83 so as to eject the recording paper 12, and the process is ended. It should be noted that, in step S83, if double-side printing is designated, the recording paper 12 is not ejected and the process proceeds to an operation to send the recording paper 12 to the double-side unit 61.

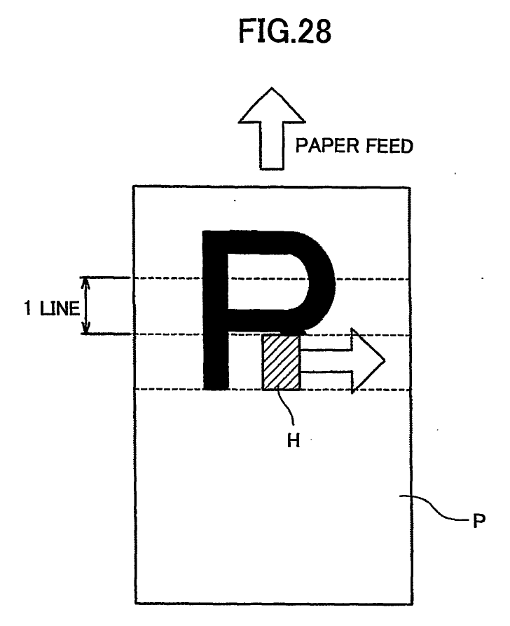

That is, similar to the image forming apparatus according to the present embodiment, according to a general operating method of an inkjet recording apparatus, a head H draws an image while moving in a direction perpendicular to a paper feed direction of a recording paper P, as shown in FIG. 28. The drawing corresponding to one line (a predetermined width) is performed at once, and, then, drawing for a next line (the same predetermined width) is performed after moving recording paper P. This operation is repeated until a whole recording paper is drawn.

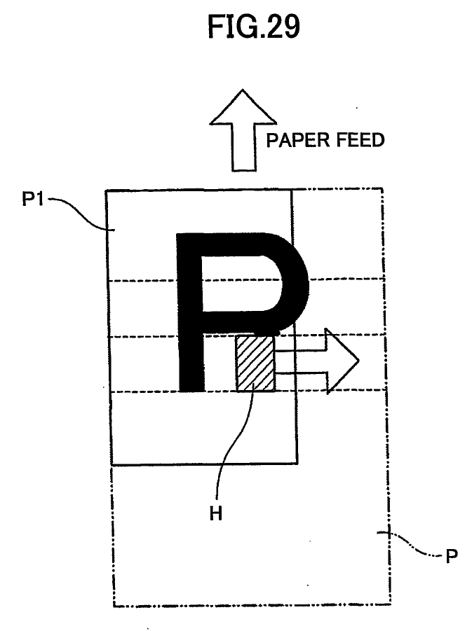

When drawing one line, a position to which a carriage having the head H is moved is determined in accordance with print setting information sent from a host. However, if there is no detection function to detect the size of the recording paper in the paper feed part of the recording apparatus, it is possible that, as shown in FIG. 29, a recording paper P1 having a width smaller than the recording paper P set by the host since there is no means for determining whether the size of the recording paper actually fed is the same as the size set by the host.

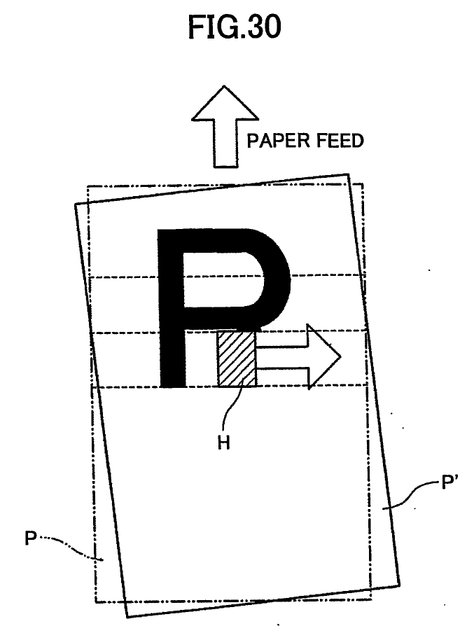

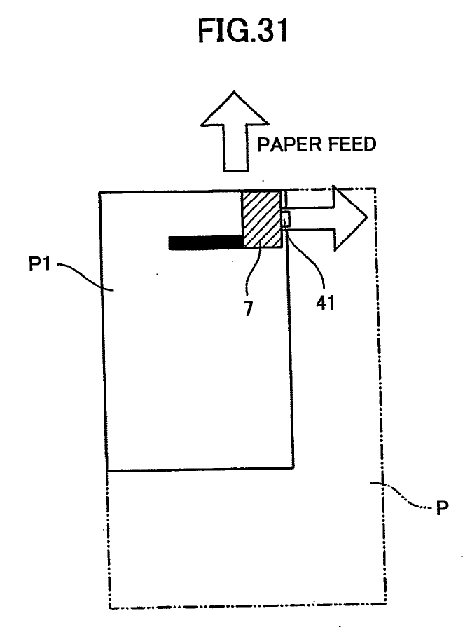

Moreover, if the recording paper P is fed in a slanted state (recording paper P′) as shown in FIG. 30, it is possible that the recording paper is not supplied to a predetermined position or the recording paper is torn. Furthermore, a formal distorted paper may be fed by a request of a user.

In such a case, the printing operation is performed on the assumption that the recording paper P of the size which was set according to print setting information is correctly fed even when the recording paper P is not present at the predetermined position. Accordingly, printing (eject of ink droplets) is performed at a position where the recording paper P1 is not present as shown in FIG. 29.

If printing is performed on a position where no recording paper is present, ink droplets adhere onto the conveyance belt 21, which causes the conveyance belt 21 blot by the ink. In such as case, the ink on the conveyance belt 21 may be transferred to a next recording paper when performing printing on the next paper, or the ink may adhere onto parts being brought into contact with the conveyance belt 21, which may shorten the service life of the apparatus. Moreover, since the printing is performed on an unnecessary position, the ink droplets are unnecessarily used, which results in waste of ink.

Thus, in the present embodiment, the state detection sensor (state detector) is mounted to the carriage 3 so that the state detection sensor detects presence of a recording paper along a moving line of the carriage 3 so as to perform printing while a recording paper being fed has a width equal to or greater than the width of the recording paper set in the print setting. Then, if it is detected in the middle of the printing that the recording paper is present, the printing operation is continued as the size of the recording paper actually supplied matches the size of the recording paper set in the print setting.

On the other hand, if the paper P1 is not detected in the middle of the carriage movement, the subsequent printing operation of the line concerned is cancelled at that time, and proceeds to a printing operation of a next line. In such a case, it is assumed that the recording paper is correctly supplied so that printing operation for the remaining lines is performed within the width of the first line in the main-scanning direction. Thus, it cannot be dealt with a case in which the recording paper is supplied in a slanted state or the recording paper is deformed, but there is no need to check the detection signal of the state detection sensor for each line (each scan line) and the printing process can be simplified.

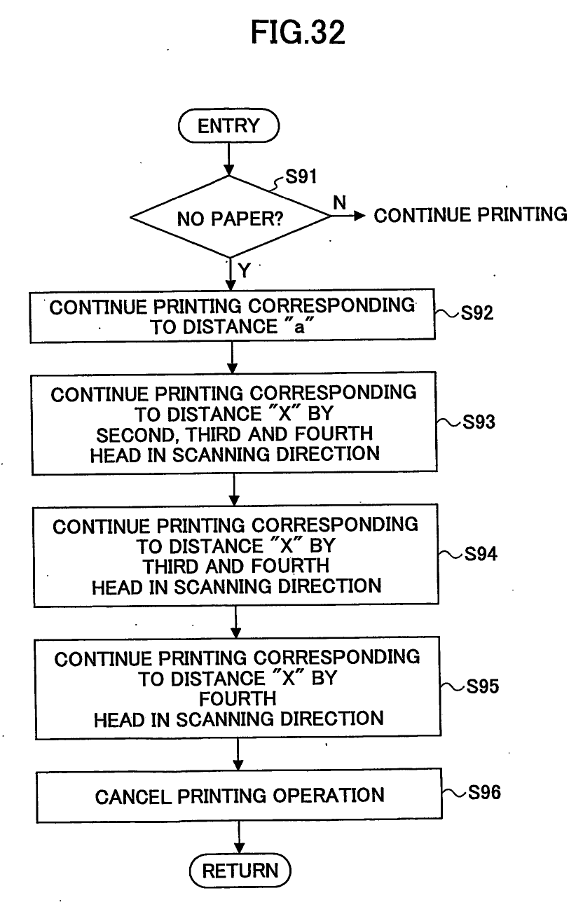

A description will now be given, with reference to FIG. 32, of a second example of the print control. Here, a description will be given of a process when no recording paper is detected in the middle of printing operation of one line until the printing operation is cancelled. In this example, as shown in FIG. 25, it is assumed that the four heads 7kh, 7h, 7mh and 7mh are arranged at an interval of “x” and the head 7yh is located at a distance “a” from a position where no paper is detected by the state detection sensor 41. It is also assumed that, in the main-scanning direction of the carriage (printing direction), the head 7yh is the first, the head 7mh is the second, the head 7ch is the third and the head 7kh is the fourth. It should be noted that, when viewed in the main-scanning direction, the head 7yh is located at a lowermost stream position and the head 7kh is located at an uppermost stream position.

As shown in FIG. 12, it is determined, in step S91, whether the recording paper 12 is present in the middle of the printing operation of one line. If it is determined that there is no recording paper in step S91, the main scan of the carriage 3 is continued, in step S92, for the distance “a” while performing the printing using the four heads 7yh, 7mh, 7ch and 7kh.

Then, after the position where the carriage 3 is moved by the distance “a”, the printing operation of the first head 7yh is cancelled, and the printing operation is continued, in step S93, by using the second through fourth heads 7mh, 7ch and 7kh while moving the carriage 3 by the distance “x”.

Additionally, after moving the carriage by the distance “x”, the printing operation of the first and second heads 7yh and 7mh is cancelled, and the printing operation is continued, in step S94, by using the third and fourth heads 7ch and 7kh while moving the carriage 3 by the distance “x”.

Further, similarly, after moving the carriage by the distance “x”, the printing operation of the first through third heads 7yh, 7mh and 7ch is cancelled, and the printing operation is continued, in step S95, by using the fourth head 7kh while moving the carriage 3 by the distance “x”. Thereafter, the printing operation of the fourth head 7kh is cancelled. Thereafter, in step S96, the remaining printing operation for the line concerned is cancelled.

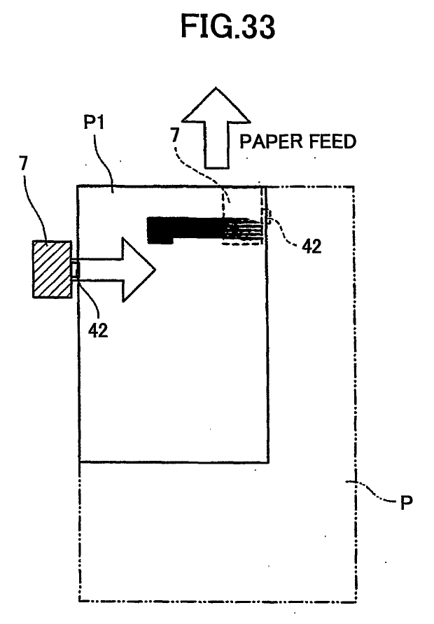

That is, as shown in FIG. 33, if the printing operation is cancelled at the time when the state detection sensor 41 detect no paper, there may be a case in which a dot lacking a necessary color ink droplet is formed due to a difference in timing of ejecting droplets from the four heads since the four heads 7yh, 7mh, 7ch and 7kh are arranged in the main-canning direction.

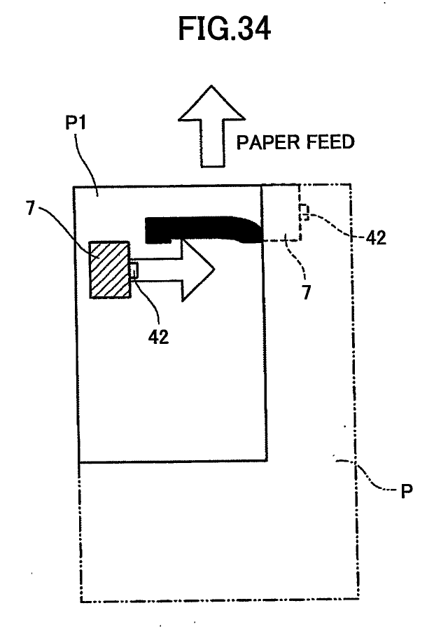

Then, with respect to the distance between the state detection sensor 41 and the first head 7yh and the distance between the four heads 7yh, 7mh, 7ch and 7kh, the printing is continued by using the head facing the recording paper. That is, by canceling the printing operation of the plurality of heads step-by step while continuing the main-scanning, necessary ink droplets can be landed on all dots and also ink droplets can be landed eve on a position very close to the edge of the recording paper. Thus, the image can be formed at a position very close to the edge of the recording paper P as shown in FIG. 34. It should be noted that a blank can be provided on the edge of the recording paper by canceling the printing operation of the first head at the time when the state detection sensor detects no paper and thereafter canceling step-by step the printing operations of other heads while continuing the main-scanning.

Additionally, if the recording head has a structure having a plurality of nozzle trains ejecting ink of different colors as shown in FIG. 26, a process similar to the process of FIG. 32 can be performed by using a distance “b” between the state detection sensor 41 and the first nozzle train 7yn and a distance “xa” between the nozzle trains.

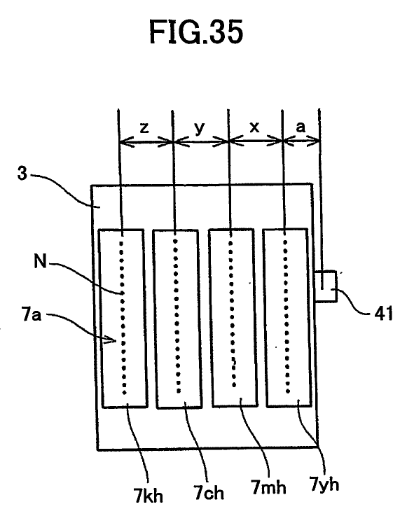

Although such a case is on the assumption that the four heads 7yh, 7mh, 7ch and 7kh are arranged at the equal head interval distance x in the main-scanning direction, the head interval distance is actually not fixed or differs from apparatus to apparatus or changed with passage of time. For example, FIG. 35 shows an example in which the distances between the four heads 7yh, 7mh, 7ch and 7kh are different from each other such as “x”, “y” and “z”, respectively.

Therefore, a head interval distance adjustment value (variations with respect to a reference value) for adjusting the distances between the heads or the head interval distances themselves are stored as information in a memory such as the above-mentioned NVRAM or ROM so as to use the adjustment value or the distances when controlling an amount of movement of the carriage 3 in the main-scanning direction after the state detection sensor 41 detects no paper and the stepwise cancellation of the printing operations, which enables an accurate printing by landing the ink droplets accurately on the same dot position by the plurality of heads.

Additionally, by using the adjustment value of the head interval distance for determining a position to cancel the printing operations due to a narrow width of the recording paper, the printing in all colors can be applied to a position very close to the edge of the recording paper.

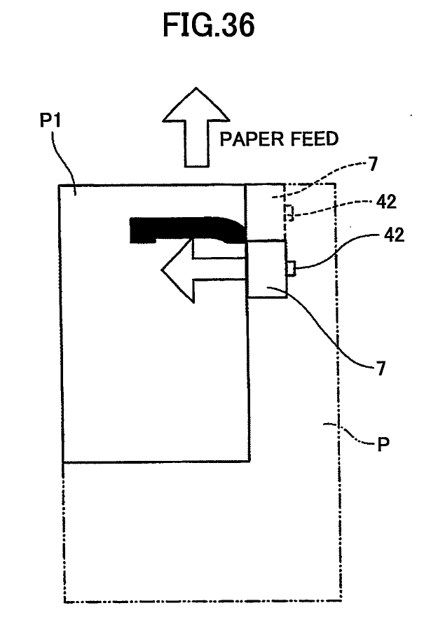

Next, a description will be given, with reference to FIG. 36, of a case as a third example of the printing control where bidirectional printing is performed. Since the carriage 3 is moved in both directions along the main-scanning line so as to print in both the outward direction an homeward direction in the bidirectional printing, the printing operation should be cancelled so that no printing is performed in an area where no paper present during the homeward movement.

For example, after printing in the outward direction by moving the carriage 3 (recording head 7) to a position indicated by dashed lines in FIG. 36, and when printing a next line in the homeward direction, the printing is started by one of the heads 7yh, 7mh, 7ch and 7kh which has moved to the position where the recording paper P is present. At this time, by canceling the print data corresponding to the area where the printing operation was cancelled in the outward direction due to outside the recording paper P1, there is no printing in the area outside the recording paper during the printing in the homeward direction, which allows appropriate printing in the bidirectional printing operation.

As mentioned above, by canceling the printing operation during the printing operation in the homeward direction in the area where the printing operation in the outward direction was cancelled, the bidirectional printing can be appropriately performed within the range where the recording paper is present.

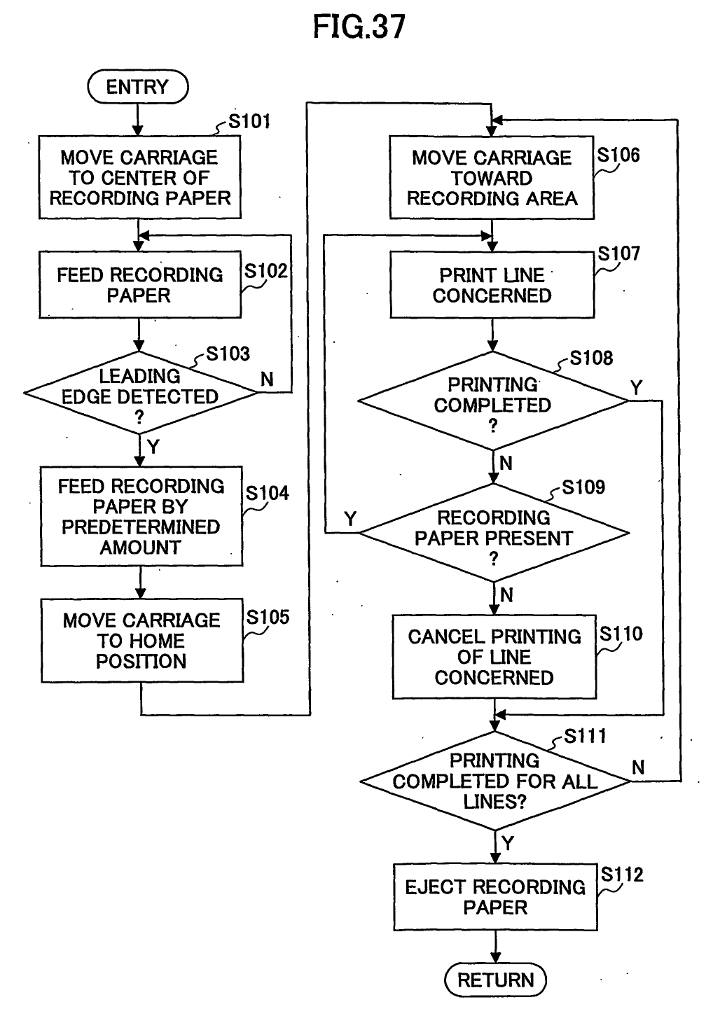

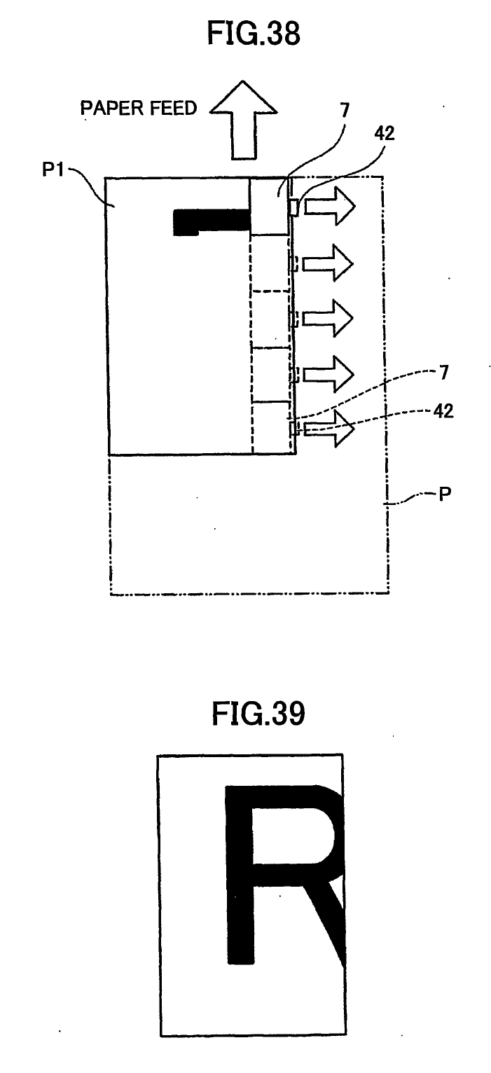

A description will now be given, with reference to FIG. 37, of a forth example of the print control.

First, in step S101, the main-scanning motor 4 is driven, prior to paper feed, so as to move the carriage 3 at a non-recordable position in a direction indicated by an outline arrow to a center part of the conveyance belt 21 (or a center of a recording paper to be fed). Then, in step S102, the paper supply clutch is turned on so as to transmit the drive force of the sub-scanning motor 31 to the feed roller 13. Thereby, the feed roller 13 makes one turn in a clockwise direction, and the recording papers 12 are separated by the friction pad 14 and fed from the paper supply tray 10.

Then, it is determined, in step S103, whether or not a leading edge of the recording paper 12 is detected by checking the detection signal of the paper sensor 41. After the leading edge of the recording paper 12 is detected, the recording paper 12 is conveyed, in step S104, to a print start position and stopped there. Thereafter, in step S105, the carriage 3 is returned temporarily to the home position, and starts moving the carriage 3 toward the recording area in accordance with the output of the encoder 44.

Then, in step S106, the carriage 3 is moved toward the recording area, and a printing operation of one line is performed in step S107. Then, it is determined, in step S108, whether or not the printing operation is completed. If the printing operation is not completed, the routine proceeds to step S109 where it is determined whether or not the recording paper 12 is present by checking the detection signal of the state detection sensor 41.

Here, if there is detected the recording paper 12 to be printed, the scanning of the carriage 3 is continued so as to continue the printing of the line concerned. On the other hand, if there is no paper 12 (when the state detector 41 detects that there is no recording paper), the routine proceeds to step S110 where a printing operation of the line concerned is cancelled. Therefore, in such a case, the printing data of the line concerned is cleared. Thus, the printing operation is not performed in an area where there is no recording paper 12, which prevents ink droplets from being landed on the conveyance belt 21, and, thereby, the conveyance belt 21 and the recording paper 12 are prevented from being blot.

After the printing operation corresponding to the line concerned is cancelled in step S110, the routine proceeds to step Sill where it is determined whether or not the printing operation for all lines is completed. If not, the routine returns to step S106. Otherwise, the routine proceeds to step S112 to eject the recording paper 12 printed, and the printing process is ended.

If the width of the recording paper is confirmed when the recording paper is supplied, it can be determined whether the supplied recording paper has a size the same as the size of the recording paper set in the print setting. However, it is possible that the recording paper is deformed or the recording paper is slanted with respect to the feeding direction. In such a case, a position of an edge of the recording paper may be changed, which results in printing on an area outside the recording paper.

Thus, in this print control, an edge of the recording paper is always monitored (detected) while printing is performed when the state detection sensor is positioned in front of the carriage 3 in the moving direction so that the printing operation of each line always ends at the edge of the recording paper and the printing operation corresponding to remaining print data is cancelled, thereby preventing printing in an area outside the recording paper.

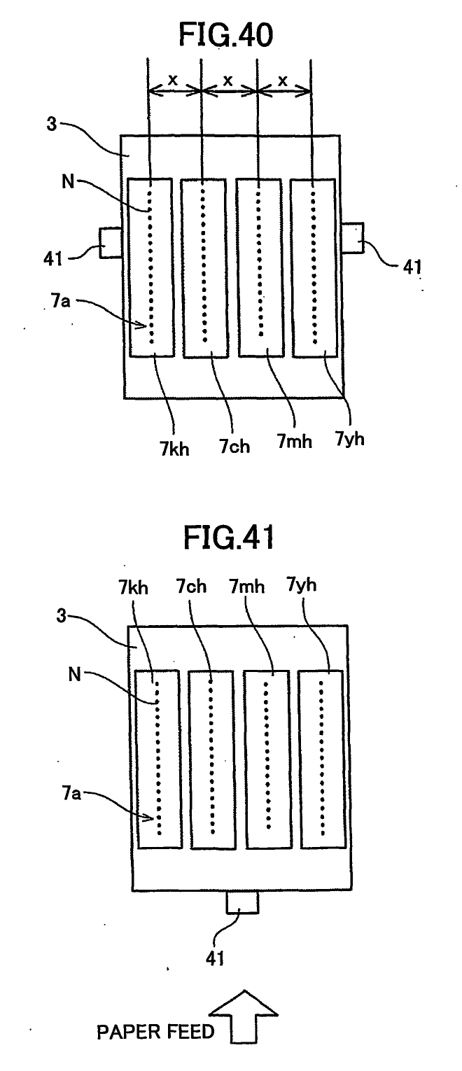

It should be noted that, when performing bidirectional printing, the edge of the recording paper can be detected either in the printing operation in an outward direction and a homeward direction by providing the state detection sensor 41 on both sides of the carriage in the main-scanning direction as shown in FIG. 40, thereby the above-mentioned print control is applicable.

A description will now be given of an inkjet recording apparatus which is a variation of the image forming apparatus according to the present embodiment. The inkjet recording apparatus of the variation has the same structure as the inkjet recording apparatus according to the above-mentioned embodiment except for the state detection sensor 41 being provided not in an upstream side of the carriage 3 in the main-scanning direction but in an upstream side of the carriage 3 in the paper feed direction (direction of conveyance of the recording paper) as shown in FIG. 41. It should be noted that the recording head 7 may have the structure having a plurality of nozzle trains as shown in 26.

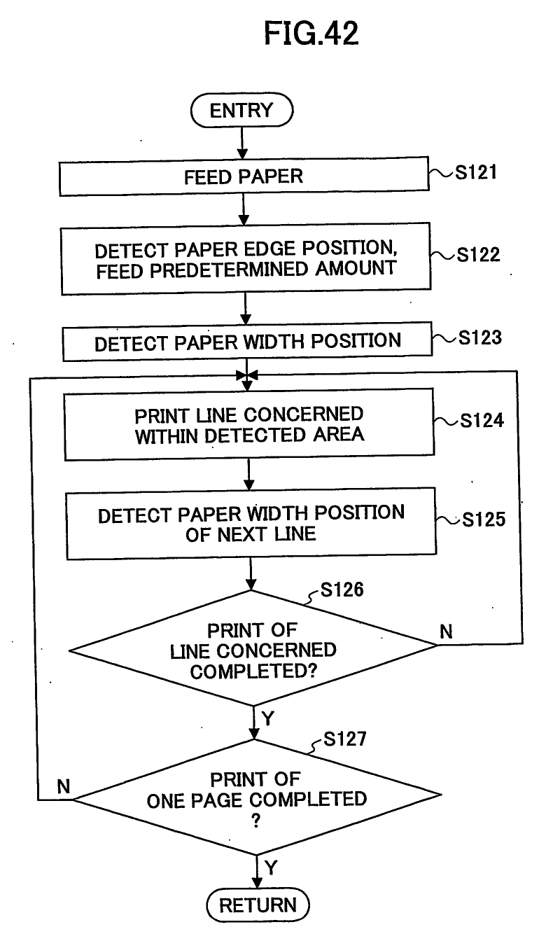

A description will now be given, with reference FIG. 42, of a print control performed by the inkjet recording apparatus.

First, in step S121, the recording paper 12 is fed. Then, in step S122, an edge of the recording paper 12 is detected and the recording paper is fed by a predetermined distance. Thereafter, in step S123, a width of the recording paper 12 is detected by moving the carriage 3 in the main-scanning direction. Then, in step S124, a printing operation is started so as to print within the width of the recording paper 12 in the main-scanning direction by the recording head 7 while moving the carriage 3 in the main-scanning direction, that is, while canceling the printing operation after detection of no paper. At this time, in step S125, the width of the recording paper 12 is determined in accordance with the result of detection of the state detection sensor 41 with respect to a line following the line being printed, that is, a line printed in the next scan of the carriage 3.

Then, it is determined, in step S126, whether or not the printing operation of the current line is completed. If the printing operation of the current line is completed, the routine proceeds to step S127 where it is determined whether or not printing operation for all lines is completed, that is, whether or not print of one page is completed. If the printing operation for all lines is completed, the print process is ended. Otherwise, the routine returns to step S124. Thereby, even if one state detection sensor is provided, printing can be performed in the bidirectional printing while canceling the printing operation after detection of no paper for each main-scanning of the carriage.

That is, although the state detection sensor can detect the edge of the recording paper prior to the recording head reaching the edge is one state detection sensor is provided in the main-scanning direction as mentioned above and when the printing is performed by moving the carriage in a normal direction where the state detection sensor is ahead of the carriage 3, it is not possible to cancel the printing operation based on the result of detection of the state detection sensor during the printing operation in a returning direction since the state detection sensor moves after the recording head when the printing operation is performed in the returning direction in the bidirectonal printing.

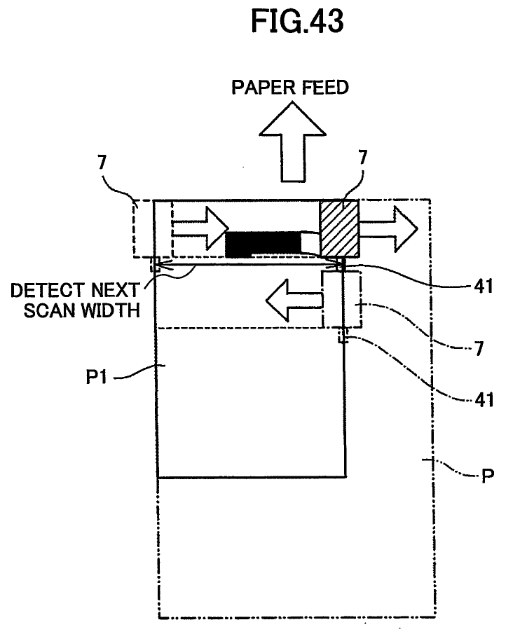

Thus, a width of the recording paper corresponding to a line next to the line being printed is monitored by providing the state detection sensor to the carriage on an upstream side of the carriage in the paper feed direction so that the printing of the next line is performed in accordance with the width of the recording paper acquired during the printing operation of the preceding line. Thus, by monitoring the width of the line following the line being printed, the bidirectional printing can be performed while monitoring the width of the recording paper for all lines as shown in FIG. 43.

It should be noted that, also in the present embodiment, if a plurality of cording heads or a plurality of nozzle trains are arranged in the main-scanning direction as mentioned above, the printing operation of the recording heads or the nozzle trains can be canceled step-by-step while continuing the movement of the carriage in the main-scanning direction until the printing of the same dot by all the recording heads or nozzle trains is completed.

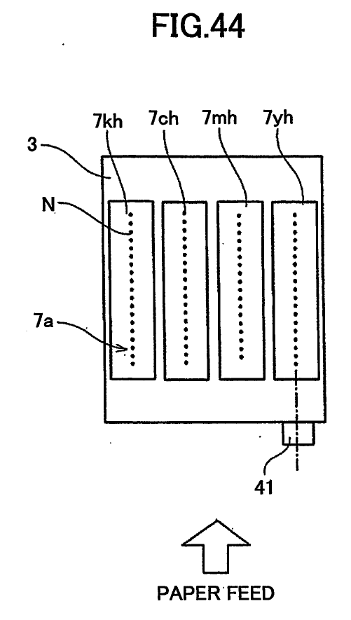

Additionally, as shown in FIG. 44, if the state detection sensor 41 is located at a position corresponding to the recording head (or nozzle train) located on an upstream side of the carriage 3 in the paper feed direction and located at the end in the main-scanning direction of the carriage 3, the edge of the recording paper can be detected while performing the printing operation of the first line. Thus, there is no need to perform a pre-scanning to detect the width of the recording paper prior to starting the printing operation.

It should be noted that although the description was made of the embodiments in which the present invention is applied to the shuttle type inkjet recording apparatus using the carriage, the present invention is not limited to the inkjet recording apparatus. That is, for example, the present invention is applicable to a copy machine, a facsimile machine, a multifunction machine incorporating a copy apparatus, a printer and a facsimile apparatus.

The present invention is not limited to the specifically disclosed embodiments, and variations and modifications may be made without departing the scope of the present invention.

1. An image forming apparatus that forms an image on a recording medium, comprising:
a carriage having a recording head to form the image by scanning the recording medium; and
a detector provided in said carriage so as to detect a leading edge of said recording medium.

2. The image forming apparatus as claimed in claim 1, further comprising an analog processing circuit that transmits an output signal of said detector.

3. The image forming apparatus as claimed in claim 1, further comprising a digital processing circuit that transmits an output signal of said detector.

4. The image forming apparatus as claimed in claim 1, wherein said detector is located at a position where said recording medium is detectable on an upstream side of an image formation start position by said recording head in a direction of conveyance of said recording medium, and also located on a side of an image forming area when said carriage is located at a home position.

5. An image forming apparatus that forms an image on a recording medium, comprising:
a carriage having a recording head to form the image by scanning the recording medium; and
a detector provided in said carriage so as to detect a width of said recording medium in a direction of scanning.

6. The image forming apparatus as claimed in claim 5, further comprising an analog processing circuit that transmits an output signal of said detector.

7. The image forming apparatus as claimed in claim 5, further comprising a digital processing circuit that transmits an output signal of said detector.

8. The image forming apparatus as claimed in claim 5, wherein said detector detects the width of said recording medium only when scanning is performed first.

9. The image forming apparatus as claimed in claim 5, wherein said detector is located at a position where said recording medium is detectable on an upstream side of an image formation start position by said recording head in a direction of conveyance of said recording medium, and also located on a side of an image forming area when said carriage is located at a home position.

10. An image forming apparatus that forms an image on a recording medium, comprising:
a carriage having a recording head to form the image by scanning the recording medium; and
a state detector that detects a state of an interior of said carriage or a state of an area surrounding said carriage, said state detector being mounted on said carriage.

11. The image forming apparatus as claimed in claim 10, wherein said state detector comprises an optical sensor having a light-emitting element emitting a light and a light-receiving element receiving the light emitted from said light-emitting element.

12. The image forming apparatus as claimed in claim 11, wherein said light-emitting element and said light-receiving element are integrated with each other.

13. The image forming apparatus as claimed in claim 10, further comprising a conveyance belt that conveys the recording medium.

14. The image forming apparatus as claimed in claim 13, further comprising a control part that determines whether said conveyance belt is dirty in accordance with a result of detection of said state detector.

15. The image forming apparatus as claimed in claim 11, wherein said state detector comprises an infrared light sensor.

16. The image forming apparatus as claimed in claim 10, wherein said state sensor comprises a temperature sensor that detects a temperature of an area surrounding said carriage.

17. The image forming apparatus as claimed in claim 16, further comprising:
a conveyance belt-that conveys the recording medium;
a drive roller that drives said conveyance belt; and
a control part that corrects an amount of rotation of said drive roller in accordance with a result of detection of said state detector.

18. The image forming apparatus as claimed in claim 16, further comprising a control part that changes a drive waveform applied to said recording head in accordance a result of detection of said state detector.

19. The image forming apparatus as claimed in claim 16, further comprising: a drive part that drives said carriage; and
a control part that changes a drive waveform applied to said drive part in accordance with a result of detection of said state detector.

20. An image forming apparatus that forms an image on a recording medium, comprising:
a carriage having a recording head to form the image by scanning the recording medium; and
a state detector including an optical sensor that is mounted on said carriage so as to detect a state of an area surrounding said carriage.

21. The image forming apparatus as claimed in claim 20, wherein said state detector determines a kind of the recording medium in accordance with a result of detection of said optical sensor.

22. The image forming apparatus as claimed in claim 21, wherein the kind of the recording medium is determined in accordance with an analog output level of said optical sensor.

23. The image forming apparatus as claimed in claim 21, further comprising a conveyance member that conveys the recording medium by attaching the recording medium to a predetermined area of said a surface of said conveyance member, and wherein said state detector detects a state of the surface of said conveyance member.

24. The image forming apparatus as claimed in claim 23, wherein said conveyance member is an endless conveyance belt.

25. The image forming apparatus as claimed in claim 24, wherein said state detector detects blot on said conveyance belt in accordance with a result of detection of said optical sensor.

26. The image forming apparatus as claimed in claim 24, wherein said state detector detects damage on said conveyance belt in accordance with a result of detection of said optical sensor.

27. The image forming apparatus as claimed in claim 21, wherein component parts other than a conveyance part, which is present within a detectable area of said state detector so as to convey the recording medium, have color density levels different from a color density level of the recording medium being conveyed by the conveyance part.

28. The image forming apparatus as claimed in claim 27, wherein the color density levels of the component parts other than said conveyance part are different from a color density level of said conveyance part.

29. An image forming apparatus that forms an image on a recording medium, comprising:
a carriage having a recording head to form the image by scanning the recording medium;
an optical sensor that is mounted on said carriage; and
component parts other than a conveyance part, which is present within a detectable area of said optical sensor so as to convey the recording medium, having color density levels different from a color density level of the recording medium being conveyed by the conveyance part.

30. The image forming apparatus as claimed in claim 29, wherein the color density levels of the component parts other than said conveyance part are different from a color density level of said conveyance part.

31. An image forming apparatus comprising:
a carriage having a recording head that ejects droplets of liquid onto a recording medium for forming an image on the recording medium; and
a state detector that detects presence of the recording medium along a moving line of said carriage,
wherein when moving said carriage in a main-scanning direction to perform a printing operation, a part of the printing operation is cancelled after said state detector detects non-presence of the recording medium.

32. The image forming apparatus as claimed in claim 31, wherein said state detector is provided on an upstream side of said carriage in the main-scanning direction so as to cancel the part of the printing operation in the main-scanning direction after a position where non-presence of the recording medium is detected by said state detector in an initial scanning of said carriage for printing.

33. The image forming apparatus as claimed in claim 31, wherein said state detector is provided on an upstream side of said carriage in the main-scanning direction so as to cancel the part of the printing operation in the main-scanning direction while detecting a position the recording medium is not present for each main-scanning of said carriage for printing.

34. The image forming apparatus as claimed in claim 31, wherein a plurality of heads are provided in the recording head so as to eject droplets in a plurality of colors by being arranged in the main-scanning direction, and the main-scanning of said carriage is continued after non-presence of the recording medium is detected by said state detector so as to cancel a printing operation of each of the heads step-by-step while moving the carriage in the main-scanning direction.

35. The image forming apparatus as claimed in claim 34, wherein an amount of movement of said carriage in the main-scanning direction and cancellation of the printing operations of the heads step-by-step are controlled, after the non-presence of the recording paper is detected, in accordance with information regarding an adjustment value of intervals between the heads.

36. The image forming apparatus as claimed in claim 31, wherein a plurality of nozzle trains are provided in the recording head so as to eject droplets in a plurality of colors by being arranged in the main-scanning direction, and the main-scanning of said carriage is continued after non-presence of the recording medium is detected by said state detector so as to cancel a printing operation of each of the nozzle trains step-by-step while moving the carriage in the main-scanning direction.

37. The image forming apparatus as claimed in claim 31, wherein said carriage is movable bidirectionally so as to perform bidirectional printing, and, when a part of the printing operation in one direction is cancelled, a part of the printing operation corresponding to an area where the printing operation is cancelled in the one direction is also cancelled in the printing operation in the other direction.

38. The image forming apparatus as claimed in claim 31, wherein said carriage is movable bidirectionally so as to perform bidirectional printing, and, said state detector is provided on each side of said carriage in the main-scanning direction.

39. The image forming apparatus as claimed in claim 31, wherein said state detector is provided on an upstream side of said carriage in a feed direction of the recording medium, and the printing operation is started after said state detector detects an edge of the recording medium while scanning said carriage in the main-scanning direction, and said state detector detects the edge of the recording medium for each min-scanning of said carriage so as to determine a position of the edge of the recording medium used in the printing operation of a subsequent line.

40. The image forming apparatus as claimed in claim 39, wherein a plurality of heads are provided in the recording head so as to eject droplets in a plurality of colors by being arranged in the main-scanning direction, and the main-scanning of said carriage is continued beyond the edge of the recording medium detected by said state detector so as to cancel the printing operation of the heads step-by-step.

41. The image forming apparatus as claimed in claim 40, wherein an amount of movement of said carriage in the main-scanning direction and cancellation of the printing operations of the heads step-by-step are controlled, after each of said heads passes the edge of the recording medium, in accordance with information regarding an adjustment value of intervals between the heads.

42. The image forming apparatus as claimed in claim 39, wherein a plurality of nozzle trains are provided in the recording head so as to eject droplets in a plurality of colors by being arranged in the main-scanning direction, and the main-scanning of said carriage is continued beyond the edge of the recording medium detected by said state detector so as to cancel the printing operation of the nozzle trains step-by-step.

43. The image forming apparatus as claimed in claim 39, wherein said state detector is provided at a position corresponding to the nozzle train closest to an edge off said recording head in the main-scanning direction.

44. The image forming apparatus as claimed in claimed 31, further comprising a conveyance belt that conveys the recording medium by electrostatically attracting the recording medium onto a surface of the conveyance belt.
